(19) United States
(12) Patent Application Publication
(10) Pub. No.: US 2012/0101871 A1
(43) Pub. Date: Apr. 26, 2012

(54) USING MASKING PROPERTIES FOR MANAGEMENT OF A DYNAMIC IDENTITY TEMPLATE AS A PART OF A MARKETING AND SALES PROGRAM FOR UNIVERSAL LIFE STAGE DECISION SUPPORT

(75) Inventor: Barry S. Lieberman, Mountain View, CA (US)

(73) Assignee: Universal Passage, Inc.

(21) Appl. No.: 13/342,114

(22) Filed: Jan. 2, 2012

Related U.S. Application Data
(63) Continuation-in-part of application No. 12/321,713, filed on Jan. 24, 2009, now abandoned.
Application No. 12/321,713 is a continuation-in-part of application No. 12/288,323, filed on Oct. 18, 2008.
Application No. 12/288,323 is a continuation-in-part of application No. 12/228,333, filed on Aug. 12, 2008.
Application No. 12/228,333 is a continuation-in-part of application No. 12/157,458, filed on Jun. 11, 2008.
(60) Provisional application No. 60/964,462, filed on Aug. 13, 2007.

(51) Int. Cl. G06Q 30/02

(52) U.S. Cl. 705/7.29; 705/14.66

(57) ABSTRACT

Methods and systems for using masking properties for management of a dynamic identity template as a part of a marketing and sales program for universal life stage decision support. While masking private data, a user-defined template can be shared (pushed) to other networks, and template fields can be dynamically populated (pulled) from other networks; thus a template can grow in extensible dimensions, as well as become automatically updated. Also disclosed are techniques for be-friending based on identity template field matching, and for matching user's needs to service providers by collecting user input in profiles, creating multi-axis match objects from the profiles, and applying heuristics to create scored matches between profiles. Techniques include defining extensible profile fields, launching automated agents, and recording reported action. Users may create and manage permissions to permit other users or third party agents to populate both private and shared information in a user-defined identity profile.

### CLAIM OF PRIORITY

This application is continuation-in-part of U.S. application Ser. No. 12/321,713 filed Jan. 24, 2009 (LIEB-P0005-US), which is a continuation-in-part of, U.S. application Ser. No. 12/288,323 filed Oct. 18, 2008 (LIEB-P0004-US) which is a continuation-in-part of U.S. application Ser. No. 12/228,333 filed Aug. 12, 2008 (LIEB-P0003-US), which is a continuation-in-part of Ser. No. 12/157,458 filed Jun. 11, 2008 (LIEB-P0002-US) and claims the benefit of priority to U.S. Application Ser. No. 60/964,462 filed Aug. 13, 2007 (LIEB-P0001-US), all of the above-referenced applications are expressly incorporated by reference in their entirety, and all priorities claimed.

### COPYRIGHT NOTICE

A portion of the disclosure of this patent document contains material which is subject to copyright protection. The copyright owner has no objection to the facsimile reproduction by anyone of the patent document, or the patent disclosure, as it appears in the Patent and Trademark Office patent file or records, or in the patent file or records of any duly authorized patent authority or jurisdiction, but otherwise reserves all copyright rights.

### FIELD OF THE INVENTION

The current invention relates generally to decision support systems, and more particularly to marketing and sales programs within decision support systems for life stage decision support.

### BACKGROUND

Each and all user's data points such as their name, contact information, financial records and status, health records and status and any or all other demographic, sociographic, psychographic, and other data points could be flagged, masked or otherwise anonymized. Each of those points might be selected individually, aggregated partially or completely, in each, all or none of the instances where those users are permitted or choose how their private information is shared or made public. Furthermore, each of those data points, individually, or aggregated partially or completely, could be utilized dependent upon the respective user's manner or purpose in limiting, granting or sharing the exhibition of it or them with other users or groups of users. Users could be invited by other users or even the system administrator to offer one, some or all of their data points so they could participate in the real or virtual world communities they create themselves or are created for their consideration by the system administrator, or by that administrator for marketers or other third parties. The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Throughout the evolution of mankind, people have forever been faced with the inevitable truth that the characteristics of life change over time. In modern times, the needs associated with the characteristics of how life changes over time have been at least partially addressed by a wide range of services available to an individual or their family and others for whom they may be responsible or act as caregivers. Such services include associated or disassociated programs, products or services for financial planning, insurance, medical needs, legal services, burial services, etc.

Unfortunately, while a broad range of services are available to an individual, various sociological barriers limit the reach that the aforementioned service providers have to their prospects, and vice versa. In fact, many aspects of a coordinated life plan are counter-intuitive. Consider for example that the ‘best’ time to buy life insurance is when one is quite young—at which time there are generally few assets and few dependents to protect. On the other end of the scale, consider that an elderly person who may be in failing health and diminished soundness of mind is not in an optimal condition to work through the legalese of a will and testament, durable power of attorney, and so on.

Additionally, knowledge barriers are before individuals. That is, even if one senses the need for, say, prudent financial planning, there exists such a myriad of options available to the individual, and also such a large corpus of knowledge needed in order to make an informed decision that, too often, life stage decisions go unaddressed. Add still the sociological fact that people are often reluctant to share their personal situations with others, resulting in the consequence that they often do not even know what questions to ask, or to whom to ask the questions once known. Moreover, unlike other challenges present in modern life (e.g. bankruptcy, drug and alcohol counseling, cancer survivorship, self-awareness, etc.), there are generally no support structures that holistically integrate making life stage decisions that people face or will face.

To a limited extent, social networking via the Internet is positioned to ameliorate some of the aforementioned barriers, in particular geographic barriers and privacy issue barriers. However the state of social networking today still does not foster awareness and understanding of life stage decisions, nor does it broadly provide mentored support structures for individuals to connect with other individuals who may share some of the same life stage decision situations. In any case, current social networking sites do not provide any significantly structured experience where wisdom can emerge from amongst a sometimes overwhelming sea of knowledge that is shared only to varying degrees, nor does it provide easily accessible paths to obtain services needed once certain life stage decisions have been made. Even though emerging virtual realities (“virtual worlds”) are possible, and even though such virtual worlds show great promise for improving social networking communications, and even though such on-line communities, networks and virtual worlds have attracted many hundreds of thousands of participants (e.g. Facebook, MySpace, LinkedIn, Second Life, The Sims, There.com, etc.), such virtual worlds do not yet provide a significantly structured experience that fosters wise life stage decision support. These and other deficiencies, in turn, lead to the need for the present invention.

In the context of embodiments of the present invention and references herein, “social networks”, “on-line communities”, “real world” and “virtual worlds” may refer singularly or collectively to one, the other, or all of them together.

### SUMMARY OF THE INVENTION

Methods and systems for using masking properties for management of a dynamic identity template management as a part of a marketing and sales program for universal life stage decision support. A user-defined template can be segregated into private portions and shared portions, and can be pushed to other networks, such that certain template fields can be dynamically populated (pulled) from other networks; thus a template can grow in extensible dimensions, as well as become automatically updated. Disclosed are techniques for providing permissions (e.g., to push or pull), and for be-friending based on identity template field matching. Also provided are techniques for matching user's needs to service providers by collecting user input in profiles, creating multi-axis match objects from the profiles, and applying heuristics to create scored matches between profiles. Techniques for masking and other dynamic management of the identity profiles include defining extensible profile fields, launching automated agents corresponding to the extensible fields, and recording reported action from the automated agents. Users may create and manage permissions and masks to permit other users or third party agents to populate information in a user-defined identity profile.

### BRIEF DESCRIPTION OF THE DRAWINGS

FIG. 1 is a depiction of a method for providing virtual world advertising and data mining as a part of a marketing and sales program for universal life stage decision support, according to one embodiment.

FIG. 2A is a depiction of a method for collecting general member data, according to one embodiment.

FIG. 2B is a depiction of a form for collecting member biographical and statistical data using a screen device, according to one embodiment.

FIG. 2C is a depiction of a form for representing collected member data using slider screen devices, according to one embodiment.

FIG. 2D is a depiction of a form for representing collected member data including self diagnosis, according to one embodiment.

FIG. 2E is a depiction of a login page using screen devices, according to one embodiment.

FIG. 2F is a depiction of a form for collecting member biographical and statistical data using a screen device for self diagnosis, according to one embodiment.

FIG. 2G is a depiction of a login page using screen devices, according to one embodiment.

FIG. 3 is a depiction of a method for collecting provider data, according to one embodiment.

FIG. 4 is a depiction of a method for creating a provider match object, according to one embodiment.

FIG. 5 is a depiction of a group of template objects, according to one embodiment.

FIG. 6 is a depiction of a method for matching a member's match object to other member's match objects, according to one embodiment.

FIG. 7 is a depiction of a method for matching a member's match object to a provider's match objects, according to one embodiment.

FIG. 8 is a depiction of a method for preparing an array for presentation to a member or provider, according to one embodiment.

FIG. 9A is a depiction of a method for presenting an array to a resource provider, according to one embodiment.

FIG. 9B is a depiction of a method for correlating actions of a member to a presentation, according to one embodiment.

FIG. 9C is a depiction of a method for identifying trends from user behavior data, according to one embodiment.

FIG. 9D is a depiction of a method for adding extensible fields to a profile and defining corresponding automated agents, according to one embodiment.

FIG. 9E is a depiction of a method for launching an automated agent and storing correlated agent results, according to one embodiment.

FIG. 10 is an illustration of an environment in which the method for providing virtual world advertising and data mining as a part of a marketing and sales program for universal life stage decision support can be practiced, according to one embodiment.

FIG. 11 is an illustration of an apparatus upon which a computer program product embodied on a tangible computer-readable medium for providing virtual world advertising and data mining as a part of a marketing and sales program for universal life stage decision support could be practiced, according to one embodiment.

For purposes of clarity and brevity, like elements and components will bear the same designations and numbering throughout the figures.

### DETAILED DESCRIPTION

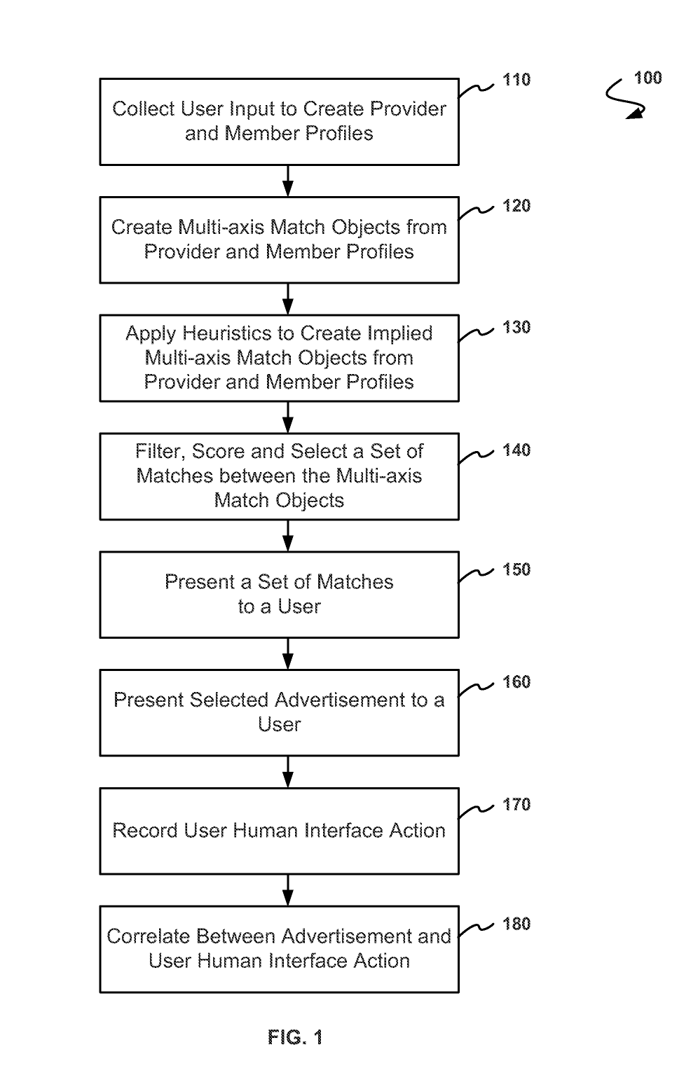

FIG. 1 depicts a system for universal life stage decision support 100 wherein persons with life stage decision support needs are matched to others with similar life stage decision support needs and wherein persons with life stage decision support needs are matched with providers who can address those needs. In a gross generalization, this is a process of matching a buyer to a seller. However, in traditional marketplaces the commodity to be exchanged for valuable consideration is most typically a well understood quantity (e.g. a 1967 Mustang convertible, or 100 shares of GOOG). However, in the case of life decision support, even though ultimately some specific commodity might be uniquely identifiable, the process and timing of selecting such a commodity is vexing.

Strictly as examples and not to be limiting, aspects and components of the process and timing of selection of such commodities might include the timing of the purchase of situationally appropriate insurance products; managing and protecting one's personal identification dataset; defining successful marriage and family protocols, especially in stressful situations; using one's genealogical history as the basis for forming an intergenerational communication of personal goals and ethical values from within which life decisions can be more productively structured; planning for the care and well-being of pets; purchasing or investing in real property; making successful choices in selecting local electrical, plumbing, construction and other contractors to remodel or upsize/downsize homes; handling estate property valuations and dispositions; detecting perpetrators of fraudulent offerings of products and services; career planning and entrepreneurial ventures; bookkeeping, compliance accounting and forward-looking tax planning; financial and estate planning; general legal planning and specific services such as formation of Trusts, estate conveyance, Advance Health Care Directives, Will and testamentary services; caring for personal needs throughout the life cycle including medical services, in-home care giving, assisted living, geriatric case management, hospice and palliative care; managing the emotional and financial ravages of degenerative diseases; planning for end-of-life memorials and funerals, etc.

Indeed, traditional (or ad hoc) avenues to life stage decisions are rife with pitfalls (e.g. no time to address decisions, overwhelming situations and paralyzing worry, rapidly changing life situations, reluctance to ask questions, inability to find support, lack of awareness or education, etc), and often, life stage decisions are delayed until it is too late, or they are sometimes left entirely to chance. The system disclosed herein traverses the identification of needs, often followed by the identification of support systems, often followed by the identification of service providers, and finally the identification of one or more specific service areas of practice. Of particular importance in the embodiments disclosed herein is the concept of a virtual world. It is in the context of a virtual world that members can feel comfortable expressing themselves without attendant fears. Also within the context of a virtual world, service providers might experiment with new service offerings.

The dynamic orchestration of these endless and currently disparate or minimally and loosely associated life cycle activities is addressed in the embodiments of the invention presented herein. The methods can be practiced by a host (e.g. a website operator) or may be practiced by proxy under one or more licenses that may include privately branded niche licenses or purposes that may cover the virtual world or ‘the real world’, or both. Real world environments may include everyday situations where people meet people such as at work; through affiliation with social, civic, ethnic and religious organizations; high-net-worth or other market segment populations; and at real world or virtual world neighborhood meetings, exhibitions and conferences. Such licenses may be used to support aspects of providing materials for a life stage and financial literacy seminar series; etc. In fact such licenses may be structured as “license-in” where established properties are linked in with the systems disclosed herein. Or licenses might be “license-out” where the licensee receives a grant to use or link to the systems disclosed herein. In both cases, it is envisioned and reasonable that licensees share or leverage substantial assets of the licensor, including images and trademarks, technologies, and even entire communities of users and user data.

By way of an oversimplified description using the buyer-seller paradigm, the system for universal life stage decision support 100 must collect information from the buyer (member) and seller (provider), morph that information into a form that a computer can understand, apply some rules to make assumptions or inferences about the needs of the buyer (member), and then present to the buyer (member) one or more sellers (providers) capable of providing the needed commodity, or otherwise servicing the needs of the buyer (member). Of course, a forum with buyers and sellers may exist in the real world, or the online world, or in a virtual world. As is described herein, the characteristics of virtual worlds give buyers many more freedoms to express and behave and, indeed, such freedoms to express (including freedoms to behave) are the basis for expressions and behaviors that can be exploited by sellers to define ever more popular, ever more valuable, and possibly ever more tailored service offerings. The use of the term “real world” or “online world”, or “virtual world” within the embodiments contemplated herein are presented strictly as an option, and discussion using those terms herein is intended to be purely exemplary, and in no way limiting narrower than the claims.

While this paradigm is easy to understand, it is the enablement of one or more embodiments of the present invention that comprise the disclosure herein. As a practical matter there may be different levels of access to or availability of features, benefits or functionality found amongst the disclosure herein. It should be strongly noted therefore that the following information is set forth for illustrative purposes and should not be construed as limiting in any manner. Any of the following features may be optionally incorporated with or without the exclusion of other features described. In particular, various systems and methods and operations are presented here to the extent that one skilled in the art may readily make and use the invention herein. To wit:

FIG. 1 depicts a method for universal life stage decision support 100 comprising a group of operations which work in conjunction with each other. As shown there is a progression from one operation to another, however in various embodiments, any one operation can execute in any order, such order being executed independently of the execution of any other operation. The method for universal life stage decision support 100 includes an operation for collecting user input to create provider and member profiles 110; an operation for creating multi-axis match objects from provider and member profiles 120; an operation for applying heuristics to create implied multi-axis match objects from provider and member profiles 130; an operation for filtering, scoring and selecting a set of matches between the multi-axis match objects 140; an operation for presenting a set of matches to a user 150; an operation for presenting one or more images to a user 160; an operation for recording user human interface device actions 170; and an operation for correlating user human interface actions to the presented images 180. Now, we cover these operations in somewhat more detail in the following paragraphs.

Shown in FIG. 1 is an operation for collecting user input to create provider profiles and member profiles 110. In any market of any sort where there are goods or services to be exchanged, there must be both buyers and sellers. In the context of the present invention, buyers are termed “members”, “subscribers”, etc. and sellers are termed “providers”, “professional service providers”, etc. Buyers, sellers, members, subscribers, providers and/or professional service providers etc. can be individually or collectively sorted by one or more parameters, any one of which parameters may apply to them simultaneously. Moreover any of the aforementioned individuals or groups can be represented in both the real world and/or in one or more virtual worlds. References herein to “users”, or “user's” or a “user” or a “user's” may refer to a person or persons (real or virtual) associated as a member or a person or persons (real or virtual) associated as a provider, or both.

For the purpose of using one or more computing platforms to match members and providers, a technique is provided for creating a profile for each member and for each provider. On the basis of the contents of the profiles, members and providers can be matched. Also, various techniques are provided infra for creating the profiles, and also provided are techniques for creating and using specialized data structures for various forms of real world and/or virtual world matching. A virtual profile might be created by a member or provider, with the intent it be used in a virtual world situation. For the purposes of this disclosure, a virtual profile is any profile used in any virtual world setting, even though such a virtual profile might also be used in a real world setting, and/or might even be indistinguishable from any real world profile. A virtual profile need not contain fictitious data nor does a virtual profile require any of the aforementioned specialized data structures.

Shown in FIG. 1 is an operation for creating multi-axis match objects from provider and member profiles 120. The term “multi-axis match” in the context of the present invention refers to the fact that a match between one match object and any other match object (whether a member's match object or a provider's match object) may be matched for closeness on the basis of n-space distance, dissimilarity measure, or one or more ultrametrics. It must be recognized that the closeness of a match with regard to a particular axis (variable) may be a simple matter of arithmetic (e.g. how close is the integer 7 to the integer 10?) or it may be more subjective (e.g. how close is a career planner to a life coach?, or how close is a will to a testament?), or a match on a particular variable may be made on the basis of a non-linear function (e.g. if one requires hospice care in New York, a hospice facility located in Kentucky is not appreciably closer than a hospice facility located in Alaska). In fact, a number of techniques for computing similarities and dissimilarities and for identification of clusters (e.g. single-link, complete link, partitioning around medoids, etc) may be employed for the matchmaking operations described herein.

Shown in FIG. 1 is an operation for applying heuristics to create implied multi-axis match objects from provider and member profiles 130. One can readily recognize that capturing a member's profile by the technique of questions and answers has practical challenges. The subjectivity of those variables can be objectified when the member enters their personal data into their Life Stage Profile Organizer (also referred to herein as a Life Stage Profile, or Life Path Profile, or member profile). Still more techniques specific to the capture of a member's profile might be employed when capturing or applying heuristics to a virtual profile.

In the context of the present invention are various aids including the application of heuristics to automatically create and automatically populate implied multi-axis match objects from provider and member profiles. For example, a member who completed a portion of his/her own profile indicating his/her age as 22 years old would likely have an extremely high interest in matching to career development services. As such, the operation applies heuristics to create implied multi-axis match objects from provider and member profiles 130 relating to career building and the member (see operation 206, below). On the contrary, for example, a member who completed a portion of his/her own profile indicating his/her age as 22 years old would likely have an extremely low interest in matching to, for example, a geriatric care facility, and thus it might happen that no provider matches are offered to that member for that practice area.

Embodiments of the operation 130 might be tailored to apply to virtual profiles. For example, a subject virtual profile might inherit variables and variable values from a real world profile. Heuristics applicable to populating implied multi-axis match objects might include aspects of a virtual world that may not (or may) be found in the real world. For example, concepts/elements (e.g. avatar, prims, machinima, breadcrumbs, scripts, behaviors, etc) might not have a correspondence in the real world, nonetheless they may appear in any virtual profile(s), so accordingly embodiments of the operation 130 might include techniques for matching objects generated from one or more virtual world profiles. To be more specific (though purely exemplary) a match heuristic might be defined that uses one or more virtual profile fields to, for example, direct the user to a suggested virtual world destination or, for example, to suggest the user perform some specific activity or activities. This notion can be extended to include techniques presented as “help” in the form of impromptu virtual coaching, and may include situationally appropriate questions/answers/suggestions such as “Where can I go to get information on hospice?”, or “How can I participate with people interested in in-home elder care?”, or “How shall I spend my money?”. The mere interaction by the user in such situations may lead to the creation of multi-axis match objects, as per operations 120 and 130.

Also shown in FIG. 1 is an operation for filtering, scoring and selecting a set of matches between the multi-axis match objects 140. In most competitive markets, there are many sellers (providers) who compete for the opportunity to fulfill the needs of a prospect (member). However, for practical reasons, very few providers can be contacted or personally evaluated by the member; thus, there is a need for the system 100 to be able to filter out impossible or known undesirable providers, and further a need to score or rank the remaining providers such that the highest-scoring or most likely matches are presented to the member in some order. Conversely, from the provider's side, the task of finding qualified leads (members) is also a filtering and scoring process, and such a scoring for finding qualified leads might use extensible fields (whether populated or not) of any profile or portion of a profile (e.g. subordinate profile fields, identity fields). Various embodiments of the present invention describe mining a member database using one or more techniques for filtering and scoring a set of matches between the multi-axis match objects 140.

Also shown in FIG. 1 is an operation for presenting a set of matches to a user 150. In the context of the present invention, such a presentation to the user may be in the traditional form of an ordered list, or the presentation may employ more sophisticated techniques such as maps, funnels, 2-D, 3-D, or n-space charts, bar charts, pie charts, etc or even multi-page, navigable, and/or hierarchical presentations.

Now, with a fundamental understanding of the techniques employed in various embodiments of the invention for providing universal life stage decision support, we can turn to further details in how to make and use the invention. More illustrative information will be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

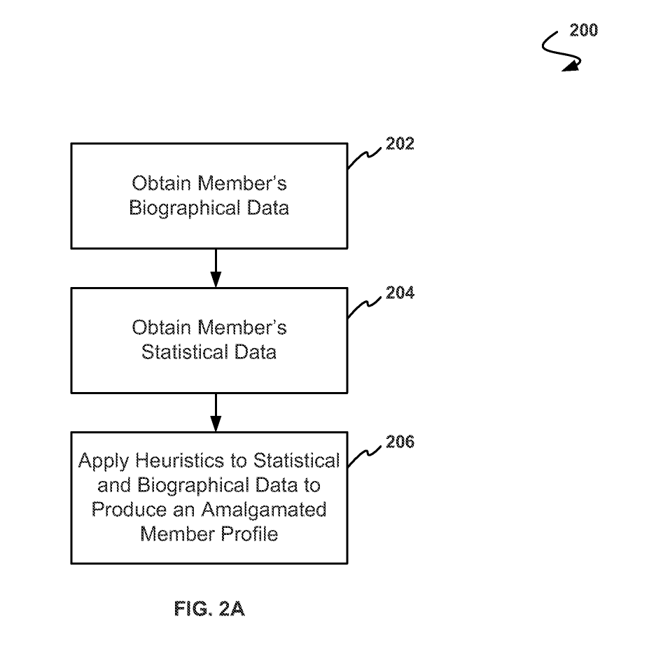

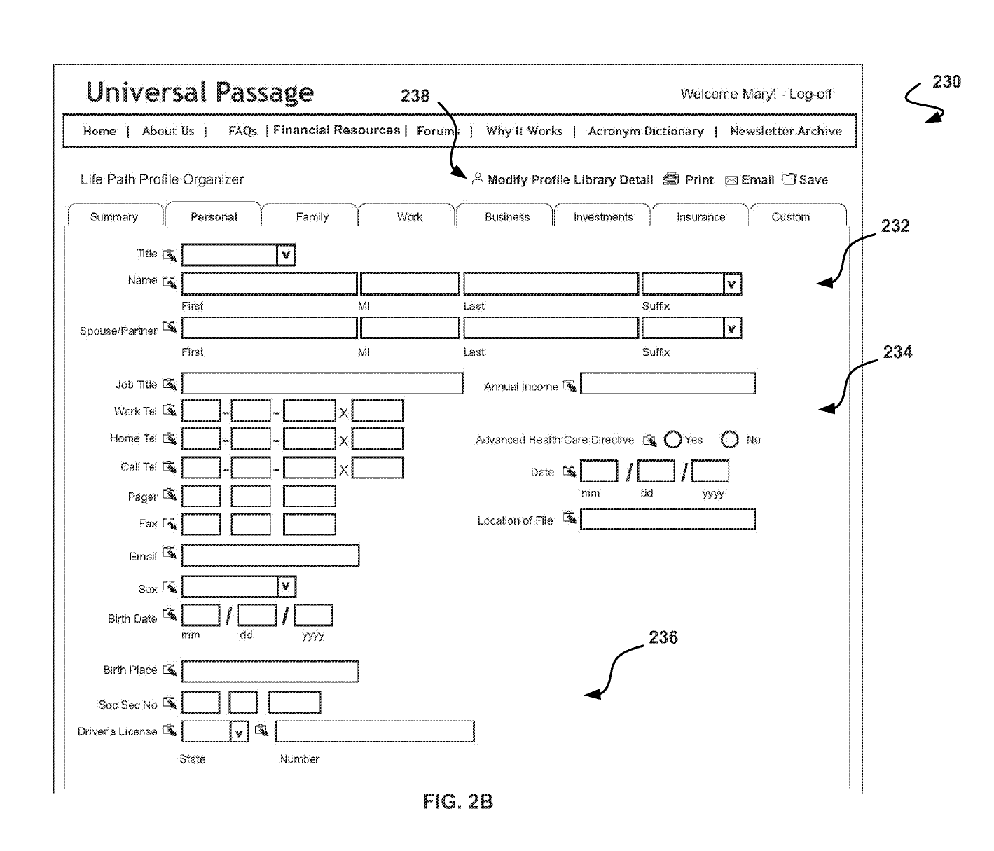

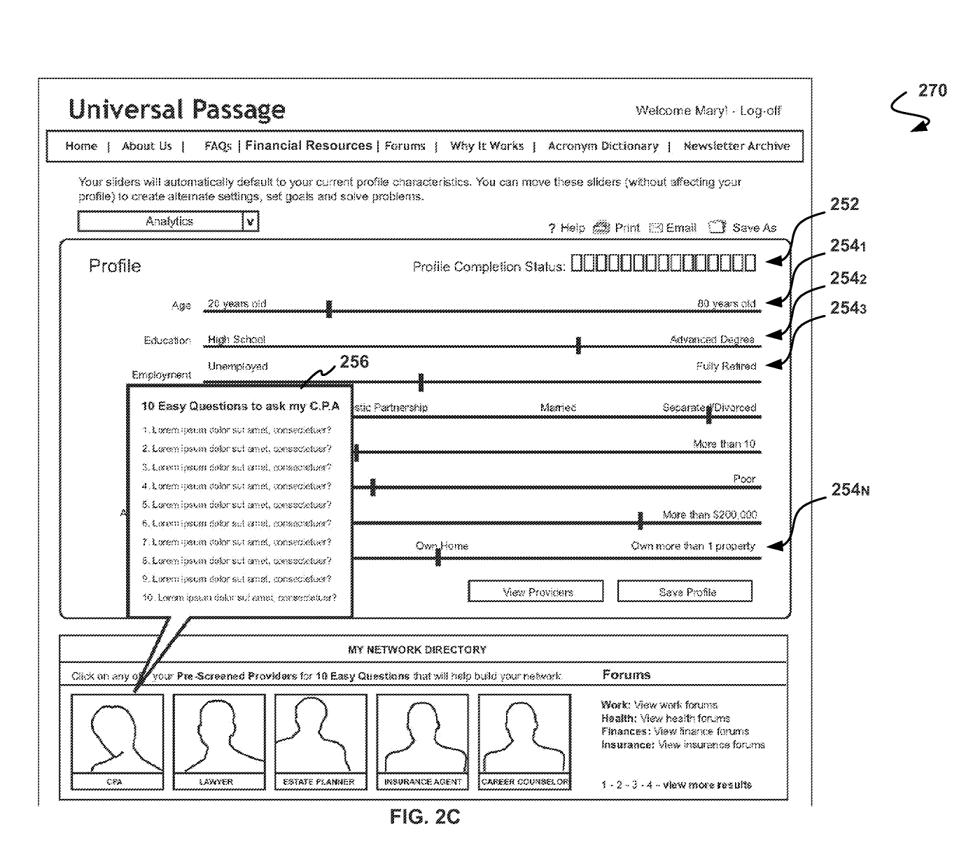

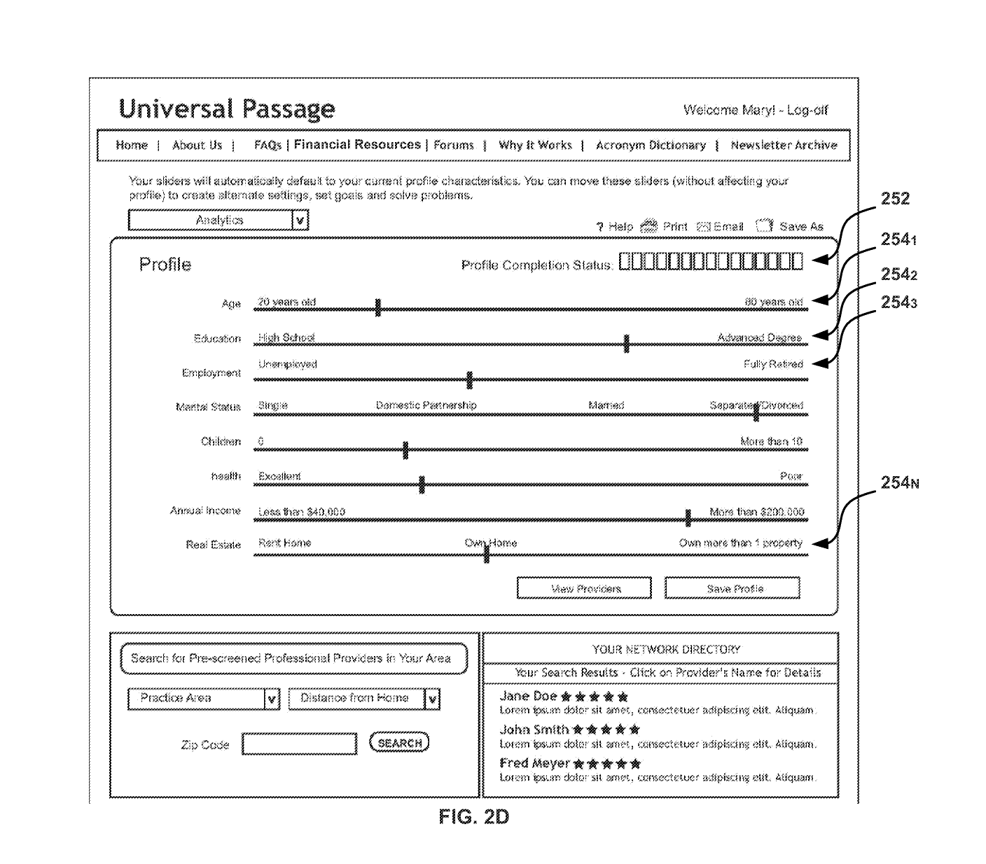

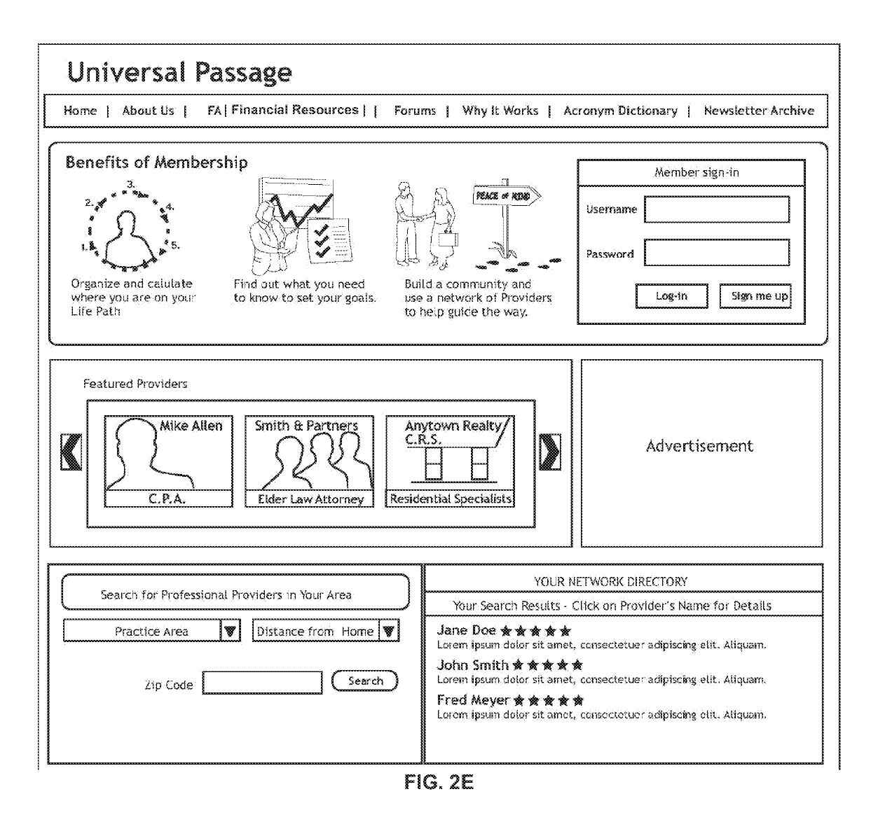

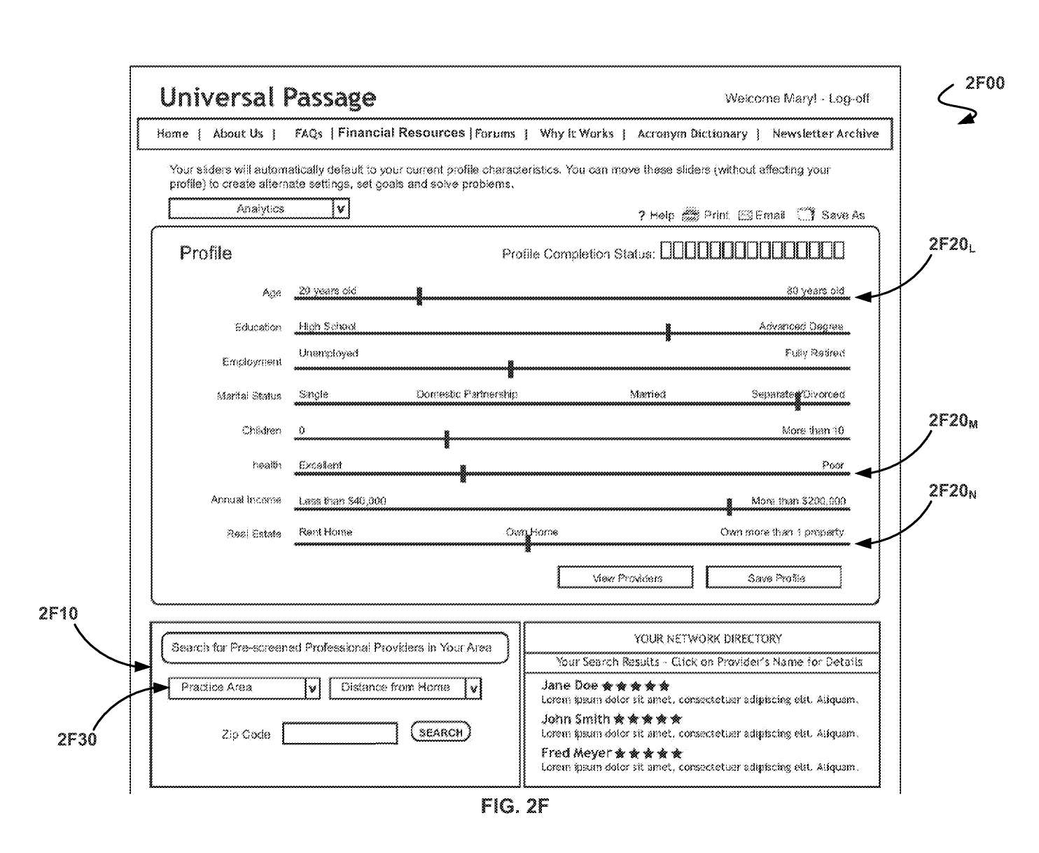

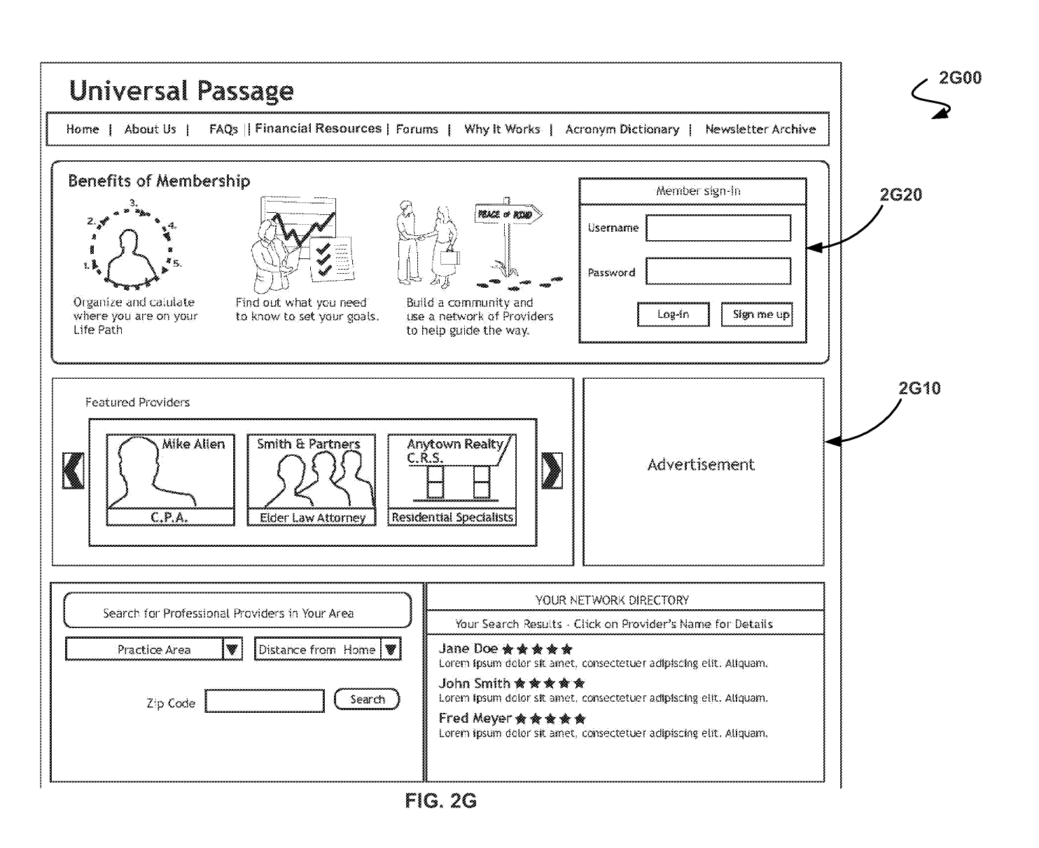

FIG. 2A shows a system 200 for collecting member input to create member profiles, in accordance with another embodiment. The member's biographical data may be obtained through any of the screen devices or other techniques discussed herein (see operation 202). Further, various statistical data may be correlated to the member. Such statistical data need not become part of the profile, in fact in a preferred embodiment, the statistical data is obtained and associated with a real or virtual member profile only upon demand (for example upon a demand by the operation 206 for applying heuristics), thus as statistics change, the correlation to the user may change (operation 204). As an option, the present system 200 may be implemented in the context of the architecture and functionality of FIG. 1. Of course, however, the system 200 or any operation therein may be carried out in any desired environment. The aforementioned definitions may apply during the present description.

In particular, the manner by which a member's biographical and statistical data (also termed, “Life Stage Profile”) might be obtained is shown in FIG. 2B (see device 230). Such biographical data may include personal identification information such as name 232, telephone number 234, social security number 236, etc. And it may include additional information regarding the user's family situation, spouse, siblings, friends, work situation, investments, insurance coverage types and limits, or even subjective information such as condition of health, favorite color, or favorite type of music. In addition to the fields shown in FIG. 2B (e.g. Title, Name, Spouse, etc), there may be additional fields, and in fact the list of fields and the content of those fields can be modified and extended by virtue of the editability (and extensibility) by either or both the member and/or the maintainer of said fields and field content data.

In fact, within the context of a virtual world, the fields and values might be purely fanciful (e.g. virtual world names), or they might be based in fact, or they might be more or less representative of a ‘desired state’ of the member. For example, the field for “Spouse/Partner” might hold a virtual value of the name of the member's Spouse/Partner in a virtual world. In a general case, profile values and new fields themselves may be imported or exported from/to any number of external entities that might be relevant. For example, a member might opt-in for the “financial situation” portion of his real world profile to be imported from his Quicken account. Conversely, a virtual profile or any portion thereto might be exported to an external entity (and updated periodically) merely by the member agreeing to opt-in to such an exchange-and-update program. As aforementioned, users may have the option to opt-in to any specific program for import/export. In some cases, imports/exports may be subject to a transactional approach for the import/export of data, possibly including the constraint of “all” or “none” or any point in between under which multiple nodes involved in an import/export operation might need to be confirmed or authorized before the import/export operation is applied.

Especially in any virtual world scenario, not only profile fields and field values, but also any characteristics or objects associated with a user (e.g. avatar, prims, machinima, breadcrumbs, scripts, behaviors, etc) might be designed to be interoperable, and capable of being exported (or imported) to (or from) another virtual world. For example, a prim defined in the Second Life world might be exported (imported) to (from) The Sims.

In some cases a data item in a virtual world profile might have one or more masking properties such that identity and other private data can be masked within the virtual world. An example of this is a virtual world email alias which is shown to virtual world participants, but which masks any of the user's real world email aliases. In still other cases, a data item in a user's virtual world profile might have meaning only in the virtual world (e.g. “number of active prims”). It is of course possible that a profile, whether a real world profile or a virtual world profile, might be embargoed or masked or otherwise restricted in part or in total by the owner of the profile. Such a limitation may affect various match operations disclosed herein.

Further, the system 200 may include an operation for obtaining a member's statistical data (see operation 204). Such information need not be stored in the profile; in fact in preferred embodiments, the statistical information (e.g. rank within percentile of Americans with the same level of education, deviation from mean as to number of children, rank within percentile of Americans with the same stated income, etc) is calculated or retrieved each time the corresponding statistical information is needed. Such statistical information can be used in processes for matching a member to other members or to providers. Still on the topic of collecting statistical information, some embodiments perform statistical analysis from within the groups of members and providers of the system 100. In fact, the results from the collection of statistical information from a group of provider profiles are used in the filtering and scoring operations. It should be recognized that virtual world profiles, although possibly fictitious, may be populated with fields and field values that have meaning only in a virtual world. Virtual world profiles are comparable to real world profiles in that they may be flagged in a manner such that they can be identified and included/excluded from various statistical analyses. For example, a male person 24 years of age might ‘experiment’ in a virtual world as a “female person 20 years of age”. Of course when generating statistics, or when generating demographic cross-sections of populations, these “experimental” virtual world profiles might be excluded. In various embodiments, a virtual profile might be required in order to enter into a virtual world. Regardless of how the virtual world profile has been populated (e.g. auto-populated from real world data, or partly or wholly fictitious) it is recognized by the systems described herein and thus can be excluded from statistics of or matching to real world data. Such identification of an acceptable range of data values can also detect erroneous or intentionally malicious population of profile fields. Monitoring and comparing such entries against usual, customary and reasonable industry standards could signal the host.

In some embodiments, and in the context of the system 200, the system 200 may present one or more explanations of one or more portions of a Life Stage Profile, be it an industry-specific or member-created subordinate profiles. More generally, some embodiments of the system 200 may otherwise provide the member with explanations, tips, help or behavioral motivation needed for completion of the steps 202 and 204.

Although the foregoing examples discuss how a member's virtual profile might be flagged, so are there many examples of how a professional service provider's profile might be flagged.

Various views of the data within a member profile (whether real or virtual) may be created within the context of system 100. The views, termed subordinate profiles, may include any arbitrary view (e.g. subset of fields) of the member profile. In fact, various input devices including web page screen devices (see discussion of analytics, below) may provide access to these views. Subordinate profiles may include fields that compare member data to industry standards and optionally to other statistically significant population samples from the real world, or from any virtual world. It must be stressed that statistics from virtual worlds may be highly valued. Specifically, even though information in virtual profiles might be, and typically is, purely fictitious or partially fictitious, or even only merely “based in fact”, such profiles both as individual profiles and as groups of profiles express desires of the individual or population. In advertising, knowledge of the trends of desires of populations can be of extremely high value, and this notion can be exploited within the context of a method and system for virtual world advertising for universal life stage decision support (see system 9C00).

A member's Life Stage Profile may also be populated through the linkage to third party products, although this is not required. Through this facility, data can be automatically populated to the member profile, and by logical extension to any views (subordinate profiles) of the member profile. In some embodiments, such linkages may be bidirectional, that is, importing and exporting (i.e. synchronizing) data from one profile to/from another profile (e.g. to/from networks such as LinkedIn, Facebook, etc). Any known techniques may be employed to facilitate such a synchronization including, but not limited to, exchange of data in an XML format that corresponds to a published XML document type definition (DTD).

In preferred embodiments, the data exchanged is referential data. That is, instead of exchanging an age for say member ACBDE99 (e.g. AGE=20) the import/export operations would import/export a reference to an age, for example using a URI or URL (e.g. http://www.UniversalPassage.com/ABCDE99/AGE.htm). Of course other techniques might be employed for exchanging information over a network (e.g. the Internet) such as GET or POST or any combination of techniques. As may be obvious, any profile composed of such synchronized data items will appear to be ‘updated’ at any viewing inasmuch as the rendering of the profile will update the data items from the referenced source document(s).

In some embodiments, as shown in FIG. 2B, a summary screen may be presented to the user with a subset of the biographical information. In a preferred embodiment, the operation for obtaining a member's biographical data 202 may employ a screen device having a plurality of sliders 254₁-254_{N} (see FIG. 2C) for representing characteristics on a scale. The sliders 254₁-254_{N} for representing characteristics on a scale may take on values according to a function relative to the dataset entered (see system 200), or as may have been entered using a screen device similar to the screed device depicted in FIG. 2B. Optionally the default setting of the sliders in the Life Stage Profile Organizer may be moved to create one or more scenarios, which scenarios may then be “saved” with a unique identifier (e.g. filename) for later retrieval of the corresponding “what if” scenario. Of course such scenarios may be intended for use in real world scenarios, or in virtual world scenarios, or both.

A particular “what if” scenario may then be saved using a name used for later retrieval (e.g. “barryat45yrsold”). Any particular configuration of sliders (i.e. a “what-if” scenario) can be used in order to produce a corresponding set of providers and related pre-qualifying questions as are discussed in detail infra (see operations 602 and 604). In other embodiments, the sliders 254₁-254_{N} might be presented to offer a member a mechanism to “self-diagnose” and possibly even “self-prescribe” (see FIG. 2F and corresponding text).

In still other embodiments, the operation to obtain a member's biographical information may include a screen device having a progress bar 252. Via the graphical screen device, the progress bar reports the relative stage of data field completion based on statistical data including deviance within a range set by industry norms for certain characteristics. For example the stage of completion for a 22-year-old single male college graduate with $20K in loans outstanding earning $65K per year, etc might include selection of a CPA but not selection of a final resting place. In this example, the progress bar might indicate a high degree of completion, indicating a narrow variance from industry and statistical norms. Conversely, a 65-year-old person who has not yet selected a hospice, nor a final resting place might show as a low degree of completion, indicating a wide variance from industry and statistical norms. Any “what-if” scenario may be saved for inclusion in the amalgamated member profile, and may be made available for later retrieval.

In the exemplary screen device 270 (see FIG. 2C), a portion of the screen may be dedicated to the display of matching providers. Display of the providers is updated as the sliders are adjusted to reflect the member's “what-if” scenario. In fact it is envisioned that a member will use the sliders to input data corresponding to a family member's or loved-one's characteristics. In this manner a member can quickly identify providers that match to a particular “what-if” scenario—even a “what-if” scenario for another person, or for a fictitious person or for a virtual world personality.

In some embodiments, whenever the profile as depicted in a screen device such as device 270 is showing a default profile (i.e. the member's profile), the display of providers includes only those providers that have not yet been selected by the member. For instance, if the member had selected a certain provider (e.g. “H and R Brick”) from the presentation of a group of providers (e.g. “Tax Preparers”), the system 100 would record such a selection, and neither “H and R Brick” nor any other providers of type “Tax Preparers” would appear on screen device 270.

In some preferred embodiments, the member's profile may be encrypted and stored in secondary storage, or may be stored (encrypted or not) at some user-specified location, optionally including on a USB flash drive or into/onto a user-specified handheld device such as a mobile phone or smart phone or personal digital assistant. It must be emphasized that although in preferred embodiments the system 200 may run through all steps encapsulated in operations 202 and 204 prior to producing an amalgamated member profile, it is possible (but strictly optional) to proceed with the operation of the system 100 even without completion of the operation 206. In similar fashion, a profile may be updated periodically as the member's situation changes (i.e. got a better job) or becomes more clear or definable (e.g. advance health care directive codified).

Given a particular “what-if” scenario as defined by the member, guiding information, possibly including an alternate selection of pre-screened providers, are presented to the member. Moreover, as further guidance to the member, and as shown in FIG. 2C, a screen device may be used to display “10 Easy Questions” 256. The “10 Easy Questions” are industry-specific and changeable in number and actual quantity count over time. The “10 Easy Questions” serve as pre-qualifiers of a provider/member relationship and may serve to establish goals, needs and requirements of each party in the relationship. Of course the “10 Easy Questions” might be partly or wholly applicable in a virtual world scenario. The “10 Easy Questions” especially as embodied in a virtual world fosters a safe, non-threatening environment where a member might role-play a situation in order to converge to some decision-making point. The virtual reality might be further applied in various real world situations. For example, a situation (whether “what-if” or real) with couples might be conducted in a virtual room such that the safe, non-threatening environment might be used to model separate rooms where each person of the couple might communicate without introducing the complexities of (real world) non-verbal behavior. Of course this notion of a room might be extended to include rooms for “anger management” or “family counseling”, or such rooms might be dedicated to providing a safe and non-threatening environment to address various topics such as inheritance, death and grief, etc. Inasmuch as those natural persons who congregate in such virtual places have real-life needs, those virtual places might also be a place where service providers might congregate in expectation of providing services.

In some cases, a provider may require information from the member. In such cases, one or more fields may need to be defined, populated by the member, and communicated to the provider. Another technique might be to augment the member profile with provider-required fields, which might be specific to a provider-type or even specific to a particular provider. The provider-required fields are defined by an extensible provider-defined subordinate profile, and subsequent to member selection of a screen device to add profile detail 238, access to a library of provider-specified fields are presented for user population. Of course many techniques may be used to reduce the number of fields presented, such as presenting only the fields from the library that correspond to the user's selected providers. Yet another embodiment includes a professional provider-independent technique as shown in the lower left corner of FIG. 2D.

One result of the practice of method 200 is an amalgamated member profile containing user-provided data, some of which may be sensitive, personal or otherwise not intended for unrestricted access by any other entity, person or computer program. Accordingly the amalgamated member profile may be singly or doubly password protected and optionally encrypted. In various embodiments employing double password protection a user may permit access (e.g. READ-ONLY, READ-WRITE, READ-PARTIAL, WRITE-PARTIAL etc) to entities, persons or computer programs that the user specifically authorizes. For example, a user may specifically authorize access by people that the member has selected to act as their Financial and Healthcare Powers of Attorney. In some embodiments, one or more of a member's subordinate profiles are single password protected and optionally encrypted. Passwords may be member configurable and changeable. In some embodiments, user passwords are stored in encrypted forms.

Of course embodiments may present options to a user to communicate or allow managed access to all or part of a member's profile. Such access may be granted to specific providers or other real or virtual users or advertisers, etc. with whom the user chooses to interact. In some cases access to such a communicated dataset may be possible only as long as the recipient has the applicable password. In various embodiments, selected types of communication of any changes to the underlying data (e.g. a member's profile) since their last communication may be depicted using a technique for highlighting such changed data. A copy of each authorization is retained and can be accessed on demand. As previously indicated, any field within the master Life Stage Organizer database into which an entry is added or changed or removed by the member will automatically trigger modification of subordinate and/or exported/synchronized profiles into which the identical field or fields have been included. Of course a member may choose to back up changes to any number of storage medium (USB key, hard drive, CD, etc.).

In some embodiments, a user is offered a range of controls as pertains to the content, operation, and purpose of a profile or subordinate profile. Specifically, and especially when a user's profile or subordinate profile is desired to be shared by the user as regards to expressed content, operations, and purposes, a user might be offered an option for content (e.g. storing profile information at one or more sites, and/or in/on one or more media). For example, a user might be offered the opportunity to store user data on a USB flash device, or on a flash card, or on a subscriber identification module (SIM), and of which might be used from any arbitrary location. Or, a user might be offered the opportunity to store and optionally share the user's data through a third party. In exemplary cases of storing and optionally sharing the user's data through a third party, the third party might offer a ‘vault’ service under which the user retains a passkey that serves as a master passkey to any number of user's profiles, any number of user's subordinate profiles, any number of permissions or restrictions, and/or any other information related to the operation on user data (e.g. storage, retrieval, and sharing). Emphatically, it is possible and envisioned that storage, retrieval, and sharing of user data extends to storage, retrieval, and sharing through third-party networks (e.g. to/from networks such as LinkedIn, Facebook, etc), and legal considerations might suggest that any opt-in devices or controls include user-specified purpose permissions or limitations. Moreover, since some information found in a user's profile or subordinate profile might overlap (in whole or in part) with any profile or user data associated with such third-party networks, such overlapping might be automatically amalgamated within the context of universal life stage decision support. Accordingly, the notion of dynamic identity template management is disclosed herein. Inasmuch as linkages to third-party networks may be bidirectional, the actions of importing and exporting, and synchronizing data from one profile to/from another profile establishes the dynamic nature of templates. Of course, any known techniques may be employed to facilitate such a synchronization including, but not limited to, “push” technologies, “pull” technologies or other upload/download and/or exchange of data, possibly in an XML format that corresponds to a published XML document type definition (DTD). Additionally, user-directed management of the dynamic characteristics of template management (e.g. user-defined identity, permissions to access locations, privileges to publish or exchange information, permissions to push-allow, push-deny, permissions to pull-allow, pull-deny, frequency of automatic updates, etc) is provided under user-direction. Also, in the case of accessing and sharing through third-party networks, embodiments disclosed herein support use of one or more centralized passkeys, whereby (for example) a single ‘master’ passkey can be viewed as a key to a ‘vault’ within which are any/all other third-party usernames/passwords or similar credentials. Of course this capability can be applied iteratively such that when a user satisfies a single challenge for an identity credential, that credential is then in turn used to provide credentials to any number of third-party networks. This capability might even extend to vaulting by a trusted third-party where any number of username/password pairs or other credentials might be initially populated to a vault, and subsequently exchanged with any number of third-party networks, virtual worlds, and/or social networks. Even more, given a trusted third-party, interaction between networks and subnets might be facilitated for not only human-interactive uses, but also for automated operations (e.g. via batch program, or auto-bot, or bot operation), in particular for importing and exporting and synchronizing data from one profile to/from another profile. Such auto-bot interaction might occur as frequently as needed to provide the users with up-to-date profiles against which to match or perform other operations.

As mentioned above, in some cases, a member is presented with help, tips, or audio/visual aids or navigation aids. The intent of such presentation is to aid the member in surmounting any barriers that might be in the way of completing any portion of their Life Stage Profile, and presentation and use of such aids extends to dynamic identity template management of any of a user's data. FIG. 2E depicts how a series of screen devices might be combined to provide a home page including graphical help, tips, suggestions, FAQs, access to newsletters, self-diagnosis tools, provider directories, a search window for provider directories, advertisements, or audio/visual media. Within the context of virtual worlds, entire realities may be presented. That is, in a virtual world, if a sponsor (e.g. a service provider or a member) wishes to model and present a virtual reality (e.g. the offices of the service provider), such modeling is envisioned and possible. In fact, inasmuch as the aforementioned example deals with surmounting any barriers that might be in the way of completing any portion of their Life Stage Profile, a service provider might present a well developed virtual reality of an office, replete with help desks, private office, etc, and staffed with real people. In some situations, a virtual world might be well developed or well staffed, or physically large (i.e. a large number of prims) and dedicated servers might be deployed to support such large virtual worlds. Again this example is purely illustrative and is not intended to be limiting to the aforementioned real world equivalent objects and actors. In fact in virtual worlds, it is envisioned and reasonable to present bots to handle many of the kinds of questions that might be posed at, say, a help desk.

In the foregoing paragraphs, the notion of sponsoring a virtual reality is introduced. Of course, a sponsor might contract out the development work to model the aforementioned virtual reality of an office, private office, staff avatars, bots, etc. Alternatively various open-source platforms might be made available to the development community at large, and artists and programmers able to operate within the open source model might produce prims, objects, automated agents, applications, games, venues, even entire regions. Continuing with the open source discussion, even entire servers hosting all or any of the aforementioned open source code might be deployed by one or more sponsors.

The disclosure to this point has discussed techniques and operations for handling member profiles and the resulting data objects. In similar fashion, next will be discussed operations performed that pertain to providers.

It must be recognized that to enhance usefulness from the first moment of operation, the system for universal life stage decision support 100 might have a pre-populated set of providers. In various embodiments, whether real or virtual, the system 100 employs techniques to either fully automatically, or in a computer-aided manner, pre-populate the system 100 with providers. To do so, it is convenient to define a method for presenting a provider profile to a user in the form of a ranking object as per system 300. Generally speaking, any real world provider may be represented by one or more entities (e.g. avatars) in a virtual world. It is also possible that some virtual world entities are actually bots. In some embodiments, virtual world bots may conduct interviews, ask questions, respond to member questions, and may be scripted to appear lifelike. Of course any of the interaction may be conducted via text/chat, or by phone using speech recognition and speech synthesis, or even using simulated videophone with an avatar.

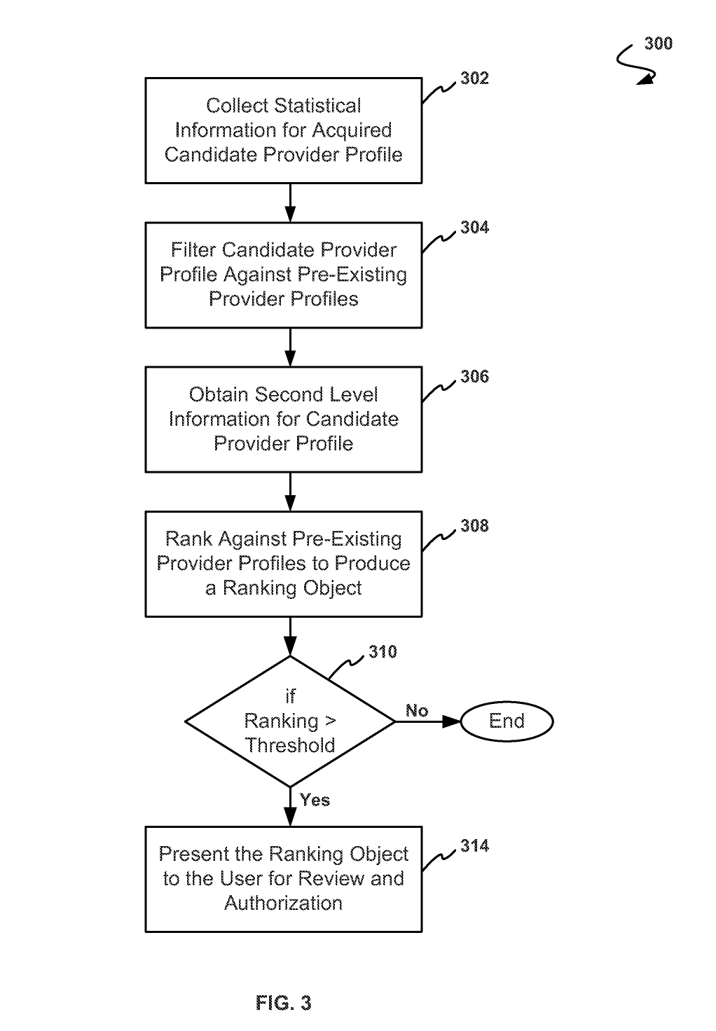

FIG. 3 shows a system for collecting provider input to create provider profiles 300, in accordance with another embodiment. As an option, the present system 300 may be implemented in the context of the architecture and functionality of FIG. 1 and FIG. 2. Of course, however, the system 300 or any operation therein may be carried out in any desired environment.

The provider profile is a data structure comprising, at the least, fields for provider name, provider contact information, description of needs served, specific needs types served (from a pulldown), etc. In exemplary embodiments, the organization of the data structure might be defined by industry-accepted parameters in order to heighten the probability of a successful match between provider and member. Strictly as an example it might include data fields as defined by one or more industry representatives. Shown in FIG. 3 is an operation to collect statistical information for an acquired candidate provider profile 302. In this operation, a provider candidate (i.e. a provider that has not yet been authorized for entry, see operation 314) becomes the subject of retrieval of general statistical information such as, into what category or provider type does the provider fit (and such provider type is captured into the provider profile), how does the candidate provider rank across all same-type providers in the nation, or how does it rank across all same-type providers covering the same geographic area, etc. In this manner a particular provider candidate may be pre-screened before being added to any list or database of providers. In some cases, the candidate provider might be a for-profit entity, or a member of a professional organization or association, or a not-for-profit organization, or even a social networking entity. Strictly as an example, a generic listing of possible entities is presented herein in Table 1. As shown the entities listed are organized into three columns corresponding to provider types for each of three exemplary life cycle phases, such phases being the accumulate phase, the conserve phase, and the resolve phase. These column headings are strictly exemplary and relatively more or less granular lists are possible and conceived.

TABLE 1

| Provider Type: | Provider Type: | Provider Type: |
|---|---|---|
| Accumulate Phase | Conserve Phase | Resolve Phase |
| Career Management Alliance | Investment Adviser Association | Assisted Living Federation of |
| | | America |
| National Association of | Trusted ID | American Association of |
| Professional Organizers | | Service Coordinators |
| Financial Planning | Medic Alert | National Association of |
| Association | | Professional Geriatric Care |
| | | Managers |
| American Association of | Martindale.com | National Hospice and Palliative |
| Family and Consumer | | Care Organization |
| Services | | |
| American Bankers | Caring Bridge | International Cemetery, |
| Association | | Cremation and Funeral |
| | | Association |
| Realogy | National Family Caregivers | Final Exit Network |
| | Association | |
| Consumer Federation of | American Society on Aging | Legacy.com |
| America | | |
| National Association of | American Animal Hospital | |
| Professional Insurance | Association | |
| Agents | | |
| American Institute of | National Genealogical Society | |
| Certified Public Accountants | | |
| National Association of | Society for Human Resource | |
| Insurance and Financial | Management | |
| Advisors | | |
| | American Association for | |
| | Marriage & Family Therapy | |
| | National Association of Estate | |
| | Planners and Councils | |
| | National Academy of Elder | |
| | Law Attorneys | |

The Table 1 lists but a few of the possible entries. In fact, some embodiments collect tens of thousands of candidate providers for processing under the system for collecting provider input to create provider member profiles 300.

Continuing, in operation 304, the candidate provider is checked against statistical data acquired from provider data within the system 100. Examples of such statistical inquiry and measurements include, how many of such providers of the same provider type are already in the system 100, or how many of such providers serving the same geographic area are already in the system 100, etc.

The abovementioned operation 304 may include a filtering operation such that providers are flagged or ranked so that members can easily discover any irregularities or deviance from the provider's usual, customary, reasonable and/or required adherence to industry standards and codes of ethical behavior. The number of providers listed in any particular practice area may be limited or pre-qualified using geographic or other variables. In a virtual world the notion of usual, customary, and reasonable might be defined purely statistically, and providers might be flagged only if the subject profile value (or combination of values) are statistically within norms.

Of course automatically-generated provider profiles, even with statistical information populated within the profile, generally do not fairly represent the entire profile of the provider, so the system 300 defines an operation for obtaining second-level information for being received into said profiles 306. Those skilled in the art will readily recognize that there exist many techniques for obtaining second-level information including direct inquiry to a human operator via a screen device such as a pull-down. Regardless of the technique used to obtain information from this second-level inquiry, the specific information gathered is extensible. In other words, as time progresses and business conditions or demographics change, the form of the inquiry for this second-level information may be extended. For example, at one point in time, the second-level inquiry might ask for an “800 number”, but later in time might be broadened to inquire for a “toll free number”, and at a still later point in time, might ask for a “Skype number”. Of course the foregoing is merely an example of extensibility, and the emphasis of this paragraph is to call out the extensibility of the profiles and match objects used in the system 100.

In some cases during operations 304 and/or 306 it may become apparent that some providers may provide multiple types of services (e.g. may provide financial planning as well as being licensed or certified to handle the purchase or sale of securities, sell life insurance, etc.) and may choose to list in multiple industries. In such a case, the provider may be guided through multiple passes of the steps of system 300. In a virtual world, such a provider capable of providing multiple types of services might present in the virtual world as wholly separate entities, or may present as multiple entities and even with multiple venues, each catering to one or more specific service offerings.

Now, with a generally well-populated provider profile, the system 300 can rank the candidate provider with the profiles of other providers. So the system 300 defines an operation for ranking a provider profile relative to the profiles of other pre-existing provider profiles 308. Assuming the ranking is above some threshold value and the profile is rejected in decision 310, the profile is then prepared for presenting a match object to the user for review and authorization 314. It should be noted that all operations shown in the system 300 need not be executed strictly in the order shown, and moreover the operations for obtaining second-level information for being received into said profiles 306 and the operation for presenting a ranked match object to the user for review and authorization 314 might be performed by different individuals considering one or more variables or even considering no variables at all (e.g. an unranked list of all providers).

Now, once a provider has been vetted at least to the extent that the provider's profile can be added to the data store of the system 100, the profile may be further processed so as to facilitate operations relating to the provider.

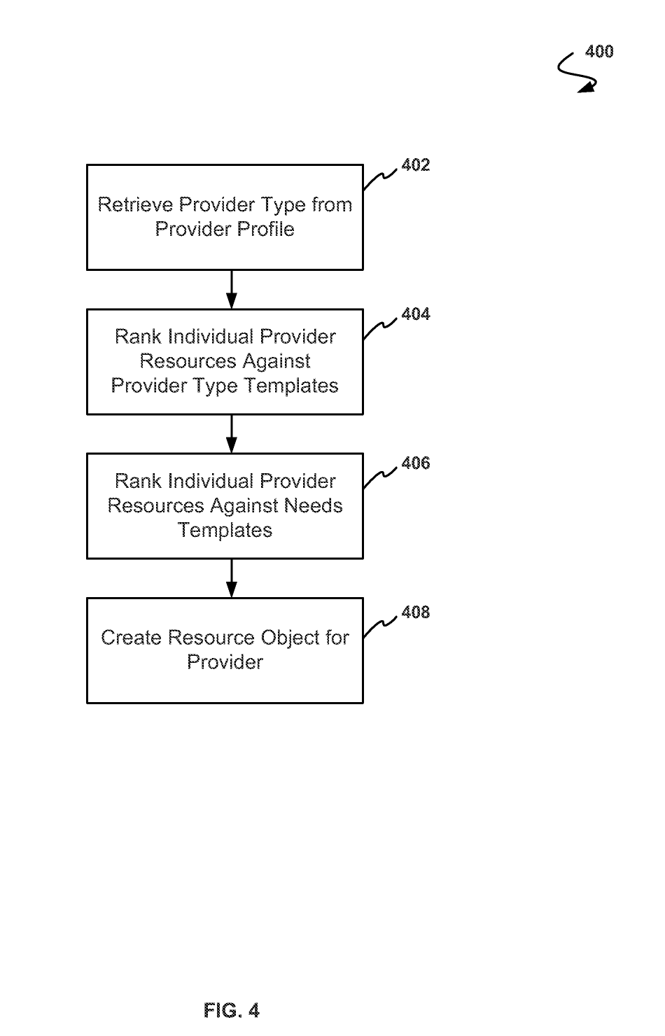

FIG. 4 shows a system 400 for creating a resource object from a provider profile, in accordance with another embodiment. As an option, the present system 400 may be implemented in the context of the architecture and functionality of FIG. 1 through FIG. 3. Of course, however, the system 400 or any operation therein may be carried out in any desired environment.

As shown the provider type is established from the provider profile in operation 402. It should be noted that in virtual worlds, a provider type may include values not traditionally associated with real world types of service. Indeed, the extensibility of a service provider profile means that new service types (and profile fields corresponding to such new service types) may be defined. In the virtual world, a provider type might be defined exclusively using virtual world constructs (e.g. forum visits, congregation, script actions, avatar popularity, etc) and might not map directly to any real world provider type. Accordingly, and inasmuch as fields may be defined and recorded in an extensible library of fields including provider-specified fields, the provider type (as well as other fields) may be managed dynamically; entering (and removing) provider types as they may occur (or become no longer used).

With the provider type known it is possible to ratify the provider type (see operation 404) and the needs template type. That is, it is possible to rank the provider resources in comparison to a list of needs templates to identify the most appropriate templates (see operation 406). As shown in Table 2, there is a many-to-many relationship between a provider type and a needs template type. For example, the Financial Planning Association (FPA) may be classified as having provider type P1, and capable of serving the needs of needs type “Financial Literacy”. And the FPA may also be classified as being capable to serve the needs for needs type “Financial Planning”. Thus the information in the profile for FPA may be evaluated in relationship to the profiles for all other providers serving the same needs types. The value of this operation should be recognized; namely while some service provider, say the Omaha Association of Financial Planners, may rank low when scored in relationship to other providers on the point of needs type “Financial Planning”, it may rank high for a member who seeks to satisfy Financial Planning needs from a provider located in Omaha. In fact there are many cases where providers belong to their State or Regional Associations but not their National Association. In virtual worlds the real world notion of an association might exist merely as an affinity as measured by behaviors. That is, since in a virtual world, actions are recordable and can be used to generate statistics, it might be wholly unnecessary to include the construct of an association. The mere statistical correlation of a provider's behaviors as compared to some qualification or as compared to another provider's behaviors might automatically credential a provider in the same manner as does membership in a real world association.

TABLE 2

| | | | Needs |
|---|---|---|---|
| | | Provider | Template |
| Needs Type | Provider Name | Type | Type |
| Financial Literacy | Financial Planning | P1 | T1 |
| | Association | | |
| Financial Planning | Financial Planning | P1 | T2 |
| | Association | | |
| Financial Planning | National Association of | P2 | T2 |
| | Insurance and Financial | | |
| | Advisors | | |
| Medical | Medic Alert | P3 | T3 |
| Emergency Support | | | |
| Career Counseling | Career Management | P4 | T4 |
| | Alliance | | |
| Financial Literacy | Omaha Association of | P1 | T1 |
| | Individual Investors | | |
| Financial Planning | Omaha Association of | P1 | T2 |
| | Individual Investors | | |

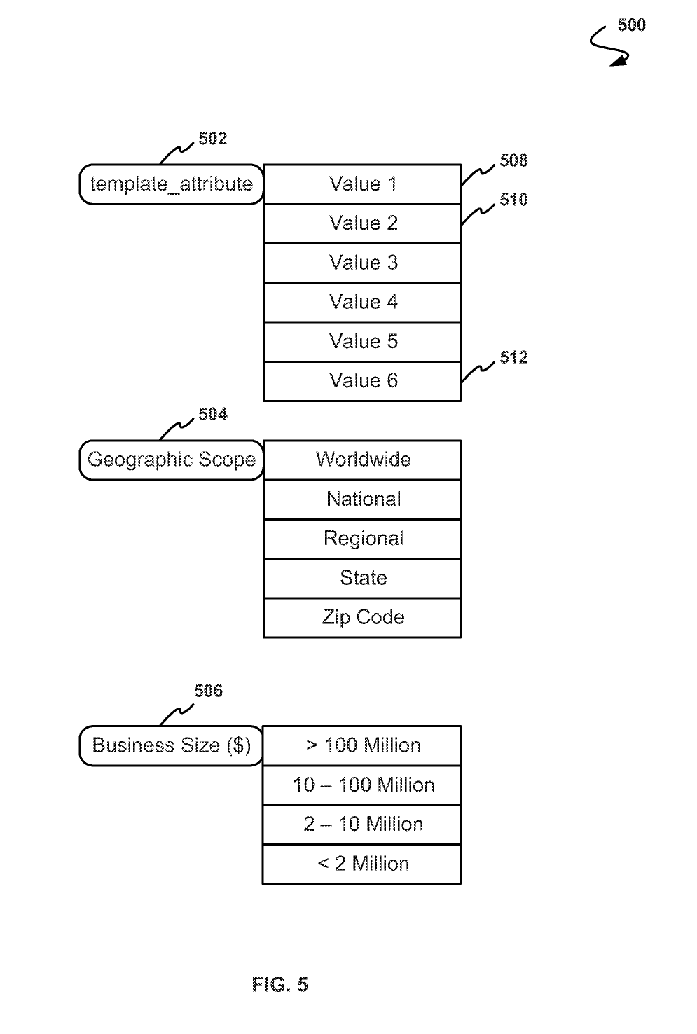

Of course, once one or more needs template types have been identified, the fields in the template may be populated. The needs template types described herein provide a technique for assigning unambiguous, objective, discrete values to various characteristics. As shown in FIG. 5, the screen devices 500 present characteristics, and possible discrete values, in accordance with another embodiment. As an option, the present system 500 may be implemented in the context of the architecture and functionality of FIG. 1 through FIG. 4. Of course, however, the system 500 or any operation therein may be carried out in any desired environment.

Strictly as an example, the aforementioned discrete values might be presented as a screen device with one or more pull-downs for (for example) geographic scope (504) for which only discrete values are presented. Even in cases of a range, discrete values may still be used, for example an inquiry into business size 506 might provide a set of one or more ranges. More generally an arbitrary template attribute can be presented as a screen device (502) with a corresponding set of discrete values (508, 510, 512).

As will be appreciated by those skilled in the art, now, with discrete values assigned to various characteristics related to the needs type of the provider as captured in the needs type, operation 406 may proceed for ranking individual provider resources against needs templates. Moreover, once the resources available have been characterized with the aforementioned discrete values, a match object for the provider can be created (operation 408).

Although the disclosure has thus far introduced the concept of a needs type, the use model has focused on the uses of needs type as applied to a provider profile. Of course, the function of system 100 to match members to providers may be facilitated by techniques to extract, infer, or respond to the self-diagnoses of the needs of the member.

In fact, as shown in FIG. 2F, the screen devices 2F00 and 2F10 offers a member a mechanism to self-diagnose and self-prescribe. A respondent might self-diagnose independently of any values of any sliders 2F20_{L}, 2F20_{M} through 2F20_{N} merely by clicking the screen device pulldown of 2F30 to select, for example, a life insurance professional located within 10 miles from home. Of course, in a virtual world, self-diagnosis might be more reflective of perceived needs or even of feigned needs. Self-diagnosis is still valuable from a statistical perspective, and in fact such statistics might be used as leading indicators of trends.

FIG. 2G includes a screen device 2G10, which screen area may be used for presenting any number of advertisements. An impression of such an advertisement is presented to any visitor to the “home” page of 2G00, regardless if the visitor is a member or provider, or both or neither. Strictly as an option, within the general advertisements placed on the home page might be “sponsored” advertisements placed by advertisers wishing to reach the broadest possible audience. Of course most advertisers are willing to increase their spend-per-impression based on increased resolution of the targeted demographic. Almost nothing can be known about a visitor to the page 2G00, however, unless the visitor were, or were to become, a member. In the case that a visitor is or becomes a member, the visitor might then login using the member sign-in device of 2G20. Once logged in, targeted advertising possibilities abound, and to the extent the a logged-in user has completed and released any profile or other demographic or even personally identifiable information, that information could be used in a targeted advertising program. In particular, an advertisement might be selected based on various member profile criteria. In fact, within the context of an online presentation of an advertisement 2G10, a particular selected advertisement might be dynamically altered to be still more specific to the characteristics of the member's profile. Otherwise stated, an ideal demographic for a provider of type “X” (e.g. a life insurance agent), is a member who has apparent life insurance needs (e.g. owns a home, and/or has a family) and is currently seeking to be matched with a provider of type “X”. Even if the indication that the member currently seeks to be matched with a provider of type “X” occurs only in a virtual world, it still (i.e. even though only in a virtual world) is an indication of some level of intent, and that indication itself might be used as a demographic in targeted advertising programs.

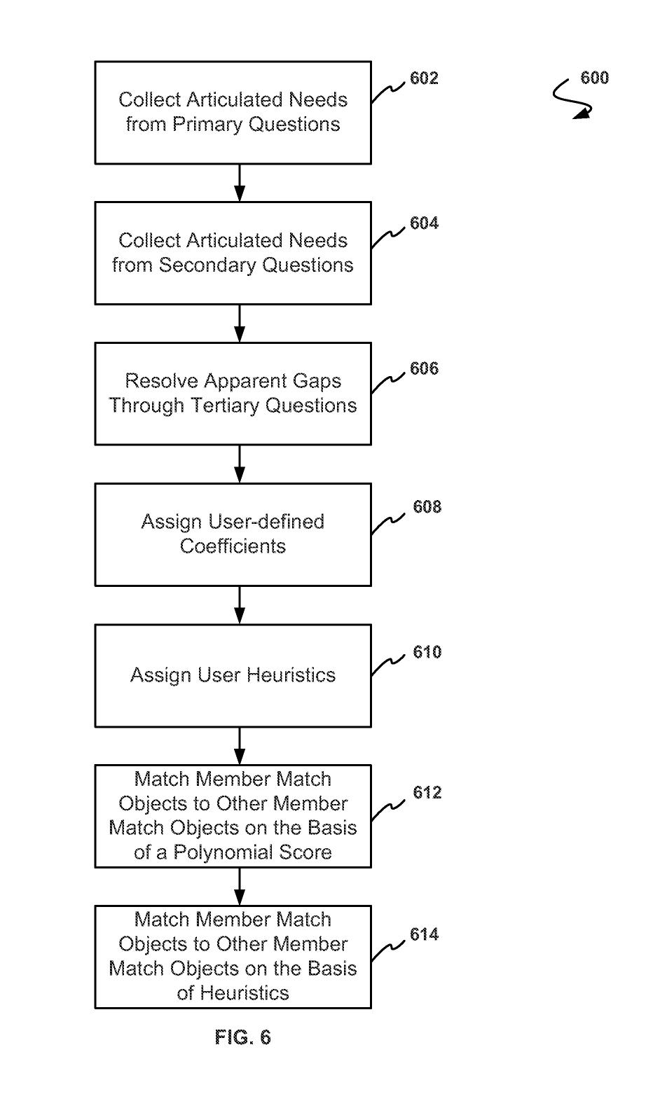

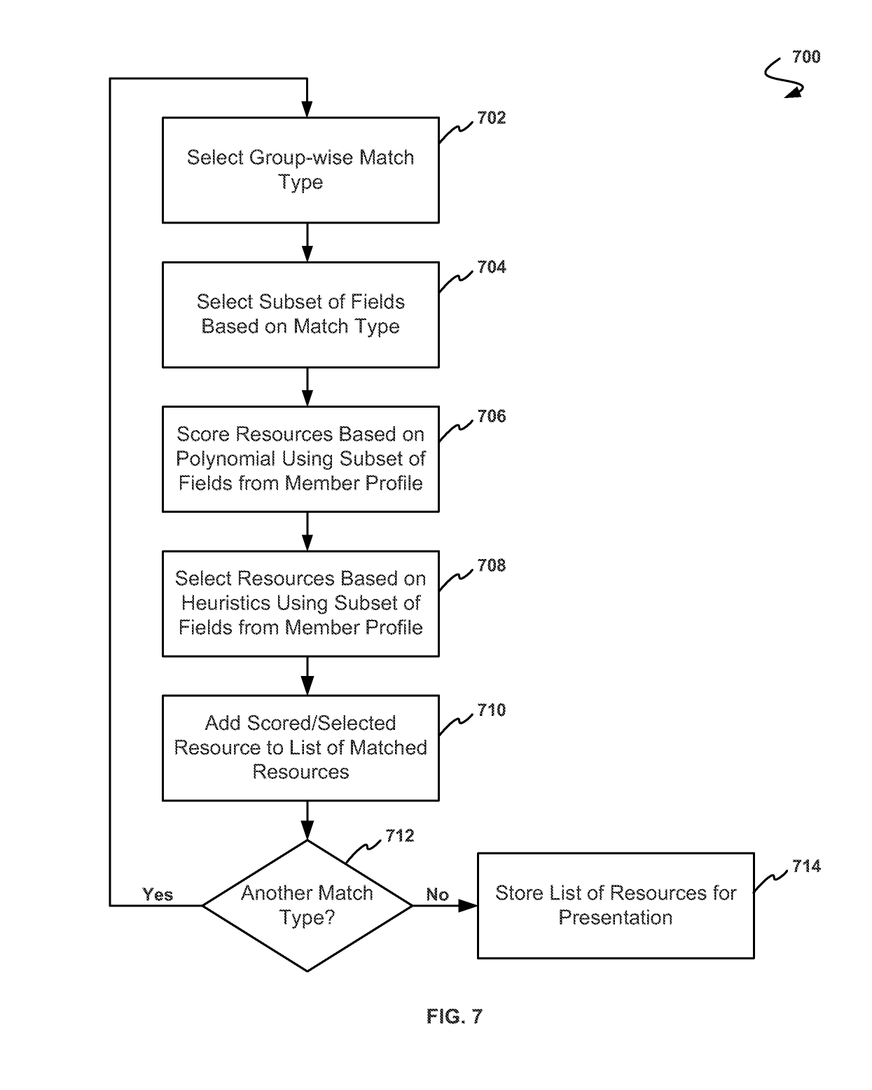

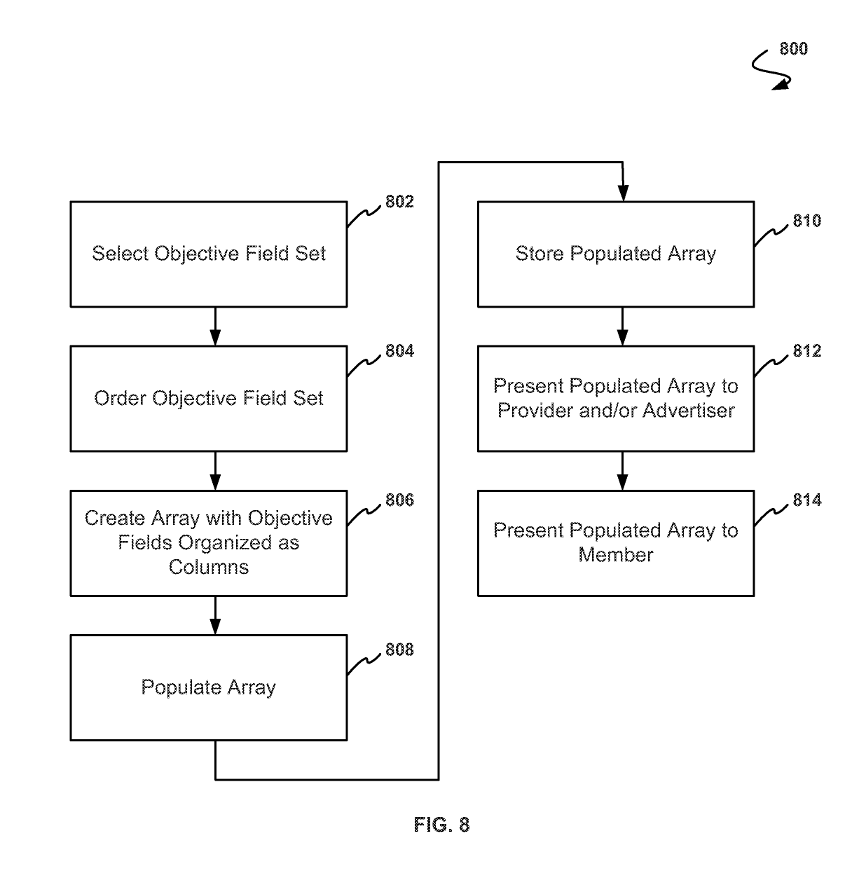

FIGS. 6 and 7 and corresponding text describe how a matching operation between a user (member or service provider) and another user (member or service provider) might be implemented. FIGS. 8, 9A, 9B, 9C, 9D, 9E, 10, and 11 show how virtual world advertising and data mining operations as a part of a marketing and sales program for universal life stage decision support might be implemented.

FIG. 6 shows a system for creating matches on the basis of needs 600, in accordance with one embodiment. As an option, the present system 600 may be implemented in the context of the architecture and functionality of FIG. 1 through FIG. 5. Of course, however, the system 600 or any operation therein may be carried out in any desired environment.

As shown the system 600 begins by assessing needs that have been articulated since they result from the member completing their Life Stage Profile Organizer However these needs could be identified at any point in time via a direct question and answer session with a member administered by a process, or may be administered “live” by telephone or chat or email, or some other real-time interactive exchange. The session could be facilitated by automation and screen devices described in FIGS. 2B through 2G, or the session may be facilitated by any other means of communication, including a telephone or personal interview. As observed, even a well considered set of primary and secondary questions may not be effective to resolve to the member's true and full needs. In some embodiments, the answers to the primary and secondary questions are analyzed to identify gaps in the answer set, and tertiary questions may then be proposed to resolve apparent gaps 606. For example, if a respondent answers through primary and secondary questioning that he/she has no appreciable assets yet again through primary and secondary questioning indicates that he/she desires two million dollars of life insurance, a possible tertiary question might be, “please confirm the number of dependents”, or even simply, “Why?” Thus the operation 606 aids in resolving gaps through tertiary questions.

As mentioned previously it should be recognized that the data in any member profile may be personally sensitive data. As such, any profile may (strictly as an option) be associated with an access key (e.g. a password, an encryption key, etc). With the articulated needs from operations 602 and 604 and the implied or resolved needs of operation 606, the system 600 may then create multi-axis match objects. Indeed, inasmuch as profile data may be sensitive, so much more does the capability of consequence-free expression in a virtual world foster identification of member feelings, root causes and acceptable solutions. The aforementioned “apparent gaps” might not be gaps in fact, but rather gaps resulting from conflicted feelings or ideas. The consequence-free experience in a virtual world affords the collection of data (for later data mining) that would be more costly to obtain in the real world.

Continuing with the discussion of the system 600, the operation 612 is for matching a member match object to other member match objects on the basis of a polynomial score. As earlier indicated, closeness of a match with regard to a particular axis may be a simple matter of arithmetic, or it may be more subjective, or a match on a particular variable may be made on the basis of a non-linear function. In general, the formula for scoring X vs. Y using a multi-axis polynomial is:

Vscore_{XY}=U1F1(x1,y1)+U2F2(x2,y2)+ . . . UnFn(xn,yn)

### Where:

U₁-Uₙ are user-defined coefficients that weight the importance of a match on a particular axis,
F₁-Fₙ are comparison functions for comparing two values within the same axis, and
x1 . . . xn and y1 . . . yn are axis values of the corresponding vectors X and Y.

Of course a scoring technique using user-defined coefficients (see operation 608) is only one way to identify one match as being relatively better than another match. And in some situations, in fact, it might be more accurate to match on the basis of heuristics or rules (see operation 610). For example and by comparison, instead of increasing a particular user coefficient to make it relatively more important than some other coefficient, it may be more effective to select/reject on the basis of set operations or other rules. For example, a match heuristic might be defined to codify the expression, “Give me only financial planners who are certified by the United States Financial Planning Certification Board and are located in Philadelphia, Pa.”. Thus the system 600 might provide an operation for matching a match object to other match objects on the basis of a heuristic match (operation 614). Of course, the aforementioned matches might be first performed on objective profile data. However, and especially in a virtual world, members might be more comfortable expressing their feelings. As such, heuristics can be developed to match to other members on the basis of feelings-oriented responses. Still further, mere behaviors in a virtual world (e.g. visits, use of specific language or keywords in chat, etc) might contribute match object fields and field values that ultimately result in a scored match.

FIG. 7 shows a system for creating a list of resources based on a plurality of match types as per system 700, in accordance with one embodiment. As an option, the present system 700 may be implemented in the context of the architecture and functionality of FIG. 1 through FIG. 6. Of course, however, the system 700 or any operation therein may be carried out in any desired environment.

The ability to perform matches involving multiple axes have thus been described, and the concept of match types may now be attended to. It is sufficient to simply mention that the number of axes or variables involved in a match (whether by scoring or by heuristics) may be unwieldy. Some means to abstract a group of related variables needs to be defined, and once defined, the match functions carried out on the group of variables can be abstracted to the match type. By way of a previously introduced example, if a member notes that a particular provider has earned various certifications (usually represented by an acronym such as CFP for a financial planner), he/she may, by using one or more GUI devices (e.g. a mouse click), access a link to that acronym definition to determine credentialing protocols and details of the certification, or certification body, or certification level, etc. That provider's membership in their state, regional or national industry-specific association can also be easily noted and a link established to determine a particular provider's standing. Thus all variables in the match object for a particular provider can be abstracted into a match type. The foregoing is merely but an example and any number of groups of variables may be defined as a group-wise match type.

As shown in FIG. 7, given a set of group-wise match types, the system 700 will iterate over the set and, based on a specific group-wise match type value (operation 702), will score (operation 706) and/or apply heuristics (operation 708) to a subset of fields using solely a subset of fields based on the specific match type, where the selected variables are associated with the selected match type (operation 704). The aforementioned association can be defined by the existence of a statically defined table, or a table or mapping may be created on the basis of any extensible functions or any other mapping technique. Strictly as an option the selection of a subset of fields based on the specific match type may include an anonymous mode for a provider, or for a member, or both, whereby the selected fields containing personally identifiable information are either not selected, or (optionally) are selected but are presented in a manner that does not divulge personally identifiable information. Once the iteration is complete (see decision 712), the scored or selected-in list (see operation 710) of providers may be stored for presentation (see operation 714). In this manner a member's network of providers may be stored and presented.

In some embodiments the creation of a member-configured subordinate profile (as detailed herein) or the use of an anonymous subordinate profile allows the member to opt-in to one or more programs for presenting their dataset to marketers and other members. The member may be provided with one or more GUI devices (e.g. a mouse click) to reveal a single or multiple identifying field to “opt-in”. In still other embodiments, the member may be offered the chance to earn remuneration by identifying themselves to, and/or purchasing goods or services offered by, providers and/or advertisers (as discussed in more detail elsewhere within).

FIG. 8 shows a system for populating an array for presentation 800, in accordance with one embodiment. As an option, the present system 800 may be implemented in the context of the architecture and functionality of FIG. 1 through FIG. 7. Of course, however, the system 800 or any operation therein may be carried out in any desired environment.

Inasmuch as providers tend to use targeted marketing techniques in order to identify qualified leads, and inasmuch as the system 100 is operable as a repository for potentially qualified leads, it is axiomatic to provide the facility to select and present members to providers or advertisers. It is well known in the art that targeted marketing becomes more effective the more narrowly the target can be defined (assuming the data exists to discern such a narrower target). Accordingly, objective field sets that are potentially interesting or valuable to providers or advertisers are selected (see operation 802) and prioritized (see operation 804). With the set of objectives both known and ordered, an array may be populated from the member data.

In another embodiment, for example, a provider may query, “Give me all members (i.e. opt-in or anonymous) residing in the state of Utah who earn over $25,000 per year and whose dataset defines a need for, or who have expressed a need for, health insurance. In such a case, the select objective field set could contain (a) a state of residence, (b) needs include “Health insurance”, and (c) yearly income greater than $25,000. The order of the objective field set would be (d) phone number, and (e) email alias. Those skilled in the art will readily recognize that a modern query language may be operable for selecting objective field sets, can express a query retrieval set (operations 802 and 804), and can also express the form of the report to be generated from the retrieval set (operations 806 and 808). The results of the aforementioned query may be stored and/or ratified/confirmed by presenting an array of match field sets to a user for user selection (operations 812 and 814).

In another embodiment, members may wish to identify other members in order to find people “just like them” using the techniques of system 700 and system 800. In such an embodiment, the array created and stored in operations 808 and 810 respectively may be presented to a member (operation 814).

There are many techniques for matching like-kind member data sets in order to find other people “just like them”, including selection of characteristics and/or ranges of values from a table. For example, as shown in Table 3, a member might use a screen device to define a query to find other people sharing the same or similar characteristics. That is selecting a group of cells in a table-like screen device might provide a sufficient amount of information (e.g. the selections) to define a query. The example below indicates selected cells with a subscript ‘x’ and defines a query for single females with a college-level education and no dependents making over 100 thousand dollars per year.

TABLE 3

| Characteristic | Person 1 | Person 2 | Entity 1 | Entity 2 |
|---|---|---|---|---|
| Marital Status | M | Sₓ | D | |
| Gender | M | Fₓ | | |
| Education | <12 | <16 | >16ₓ | |
| Dependents | 0ₓ | 1 | 2 | 3 |
| Annual Household Income | <40 | <80 | <100 | >100ₓ |

In the context of matching like-kind member data sets in virtual worlds and/or matching in the context of third-party networks, user's might avail themselves of techniques for dynamic identity matching when seeking other people “just like them”. As earlier disclosed herein, a user's profile might be periodically synchronized with profiles from third-party networks. Axiomatically, one or more subordinate profiles might be periodically synchronized with profiles from third-party networks. Thus a single real-world entity might possess any number of subordinate profiles, and therefore might avail themselves of the dynamic identity template management techniques disclosed herein. Strictly as an example, a real-world user might want to promulgate a virtual world identity (e.g. in the form of a subordinate profile) to members of a particular virtual community (e.g. Coffee Lovers of Seattle group), and might also want to find newly-joined members of that virtual world group who identify themselves as “engineers”, or as “software engineers”. The possibility to find such a match, specifically noting the condition for finding a newly-joined member, is supported by dynamic identity template management techniques. Combining the dynamically updating nature of a subordinate profile together with the extent of a third-party network (e.g. Facebook) and any affiliated networks or sub-networks, results in new techniques including new facets for be-friending new contacts.

It should be noted that the action of be-friending might match two (or more) real people together, or it might merely match two (or more) profiles together. In either case, the aforementioned permissions and privileges might be applied to control the extent of be-friending (e.g. within just one degree of friendship, or two, or more) and might be applied to control the extent of the friendship relationship itself (e.g. what information is shared, what information is exchanged, what posted chat rooms are shared, what private chat rooms or places are shared, etc.), or might even be applied to controlling the act of de-friending (e.g. removing a be-friended relationship, and/or ‘forgetting’ the relationship). It should be noted for a fuller understanding that the verb to be-friend need not carry any connotation applying strictly to a real-world friendship or social friendship. In fact, an alternative sense of be-friending might include merely providing some permission options to receive or exchange information. A be-friended entity might be a real or virtual entity, and/or might even be a bot which is not necessarily tied to any specific single person, and in fact, which bot might even be simply an information service to which a user desires to provide some level of information exchange permissions. Conversely, a be-friended entity might indeed be a real person, and that person might be ‘mobile’ by virtue of the use of a USB key (e.g. in an Internet Café), or by virtue of use a SIM card in a mobile phone, etc. In some embodiments, contacts (e.g. real or virtual entities that have been be-friended) might be ‘located’ in the real world or in virtual worlds and a spontaneous meeting might thus be facilitated. One type of such a spontaneous meeting is the formation of a spontaneous chat room, but of course technologies to locate friends in the real-world are available, and might be included in embodiments of the present invention.

As a more in-depth example, and in the context of universal life stage decision support, a user might reach service providers via third party networks, and via subordinate profiles. Conversely, service providers might reach targeted users via third party networks, and via subordinate profiles. The value of dynamic identity template management is particularly high to service providers as such automation gives service providers access to constantly changing groups of qualified, targeted leads. Similarly, qualified leads that come to a service provider's attention by application of dynamic identity template management might later become less qualified, or even disqualified by virtue of some changes made to the profile. For example, if a physician were seeking candidates for participation in a clinical drug trial, and qualified participants were required to be within a certain age range, and residing within some radius of the clinic, and have certain genetic characteristics, a semi-qualified candidate might automatically move to a fully-qualified (or disqualified) candidate at the point in time when the candidate attached his/her DNA information to his/her profile in response to the physician's dynamic extension of the corresponding subordinate profile.

While the foregoing scenario describing one application of dynamic identity template management exhibits many characteristics of a real-world situation, the scenario is in no way intended to be limiting to the real world. In fact, dynamic identity template management is especially important in virtual words, and/or in social networks.

The foregoing example, describes narrowly dynamic identity template management in that it includes extending a profile to include additional fields; however, extensibility is only one facet of dynamic identity template management. Another powerful technique facilitating dynamic identity template management is open-source platforms. Open-source platforms lay a technological foundation such that qualified developers can develop and deploy automated agents (bots) or other applications for many purposes, including for dynamic identity template management. Returning to the clinical trial study, once some metric regarding the size of the candidate pool has been reached, a program (e.g. network application, bot, etc) might be deployed to identify cohorts of some particular size. Such a cohort might be constituted by virtue of the residence locations of the candidates, or perhaps by some characteristic in the disclosed medical history, or perhaps some characteristic of the candidates' shared DNA information. As should be observed, such a network application might be best defined by personnel associated with the trial; hence an open-source platform would facilitate development and deployment. Taking this model further, service providers of any type might define applications to seek survey-style information from the addressed users, or to conduct virtual focus groups, or to otherwise market or test market service offerings.

Of course embodiments include selections from a table and/or corresponding queries that define a market basket of characteristics that present interest to providers and advertisers. Still more, the aforementioned table itself might be a representation of a market basket (or subset thereof). Such market baskets might be valued statically by their components (e.g. set floor prices for certain terms or ranges) or dynamically by some market driven auctioning, and such resulting value might be further applied to pricing for advertisements. Similarly, market baskets might be valued based on the underlying data set; for example, data based partially or exclusively on aggregate member data bearing no personally identifiable information might be seen as having lower value than data that can be correlated to a particular individual member. Still on the topic of market basket valuation, some market baskets might command a premium price merely by virtue that they are specified by a provider. For example, a provider might want to target members who are single, male, without children, earning over 100 thousand dollars per year, and have at least some college, and X, and Y, and Z, and the provider might be willing to pay M % more per click for access to such a targeted audience. Methods for establishing the cost of placement of an ad has been implemented by early Internet pioneers (e.g. Google) and more recently have become sufficiently sophisticated that a cost for placing a particular ad of a particular type to a particular property at a particular moment in time can be determined via instant on-line bidding in an on-line marketplace.

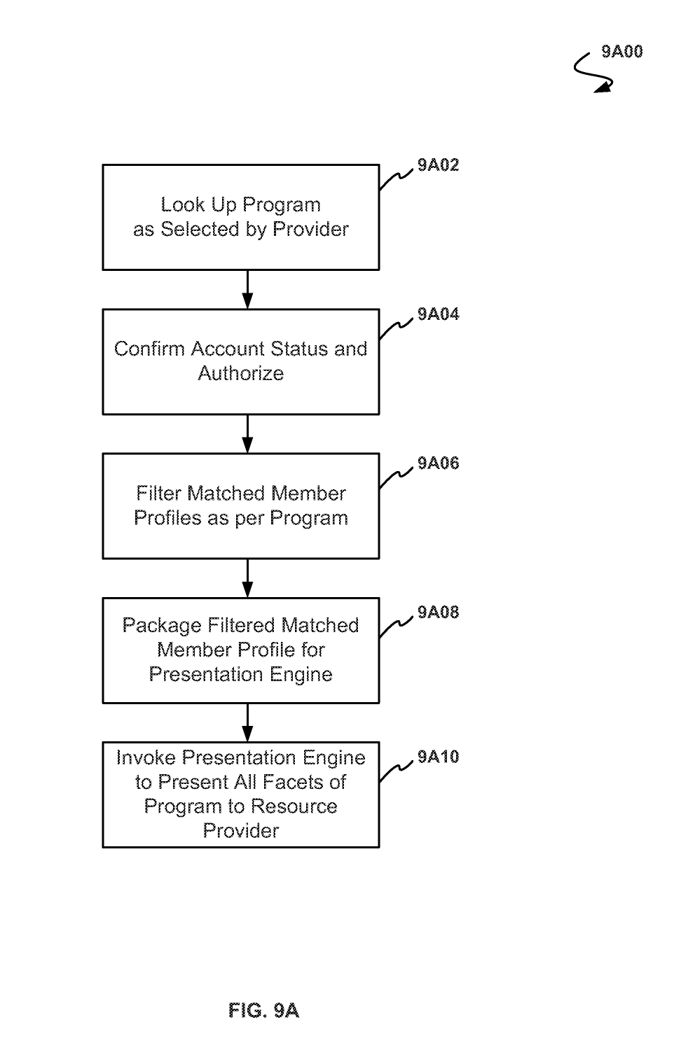

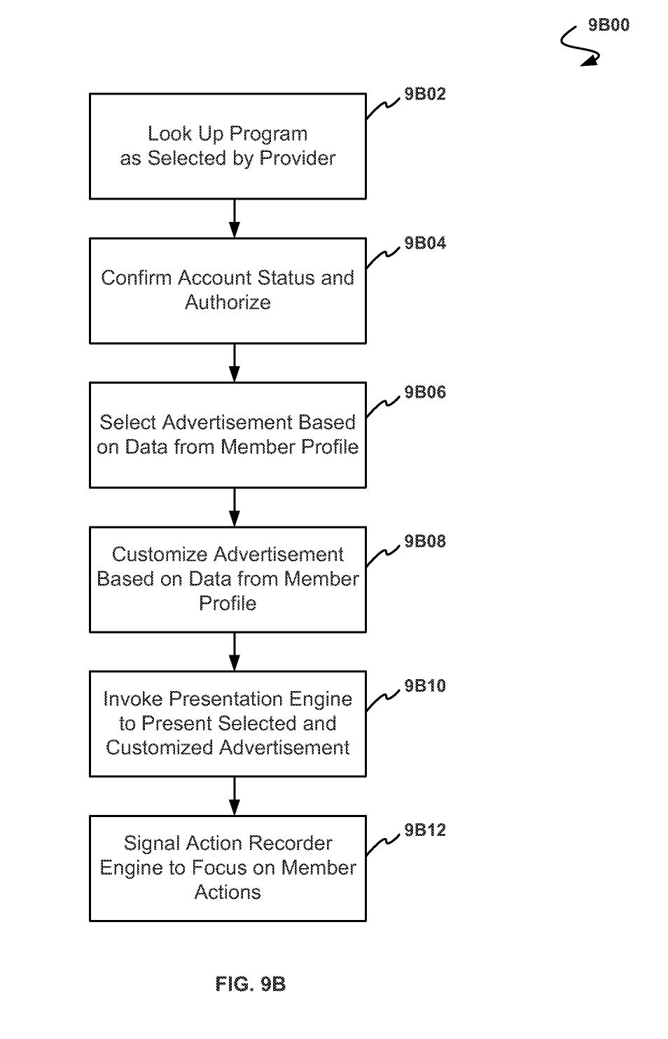

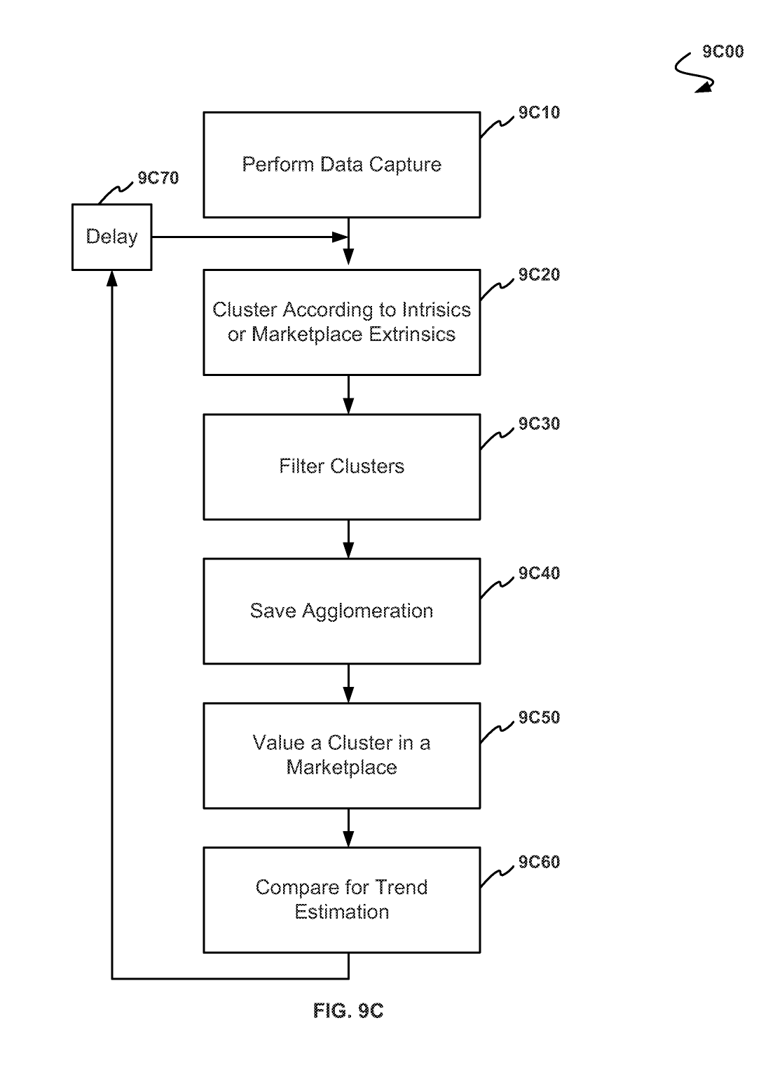

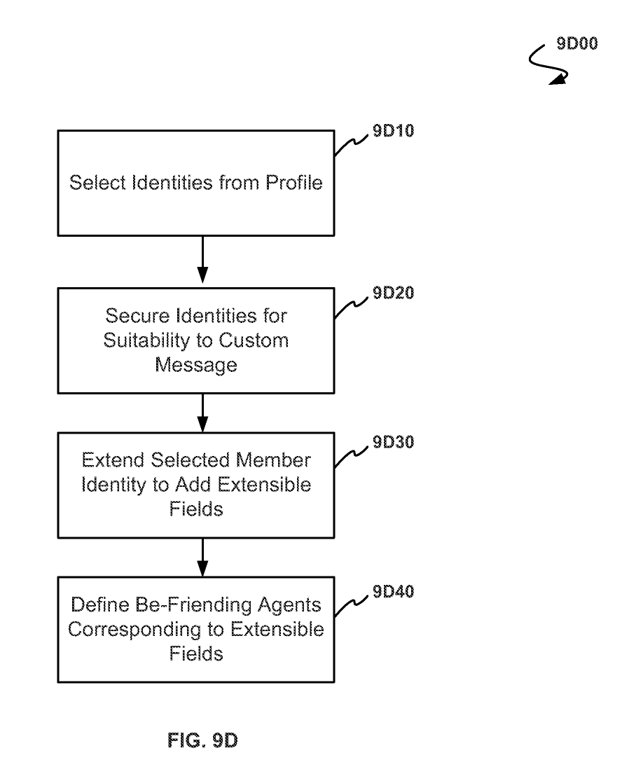

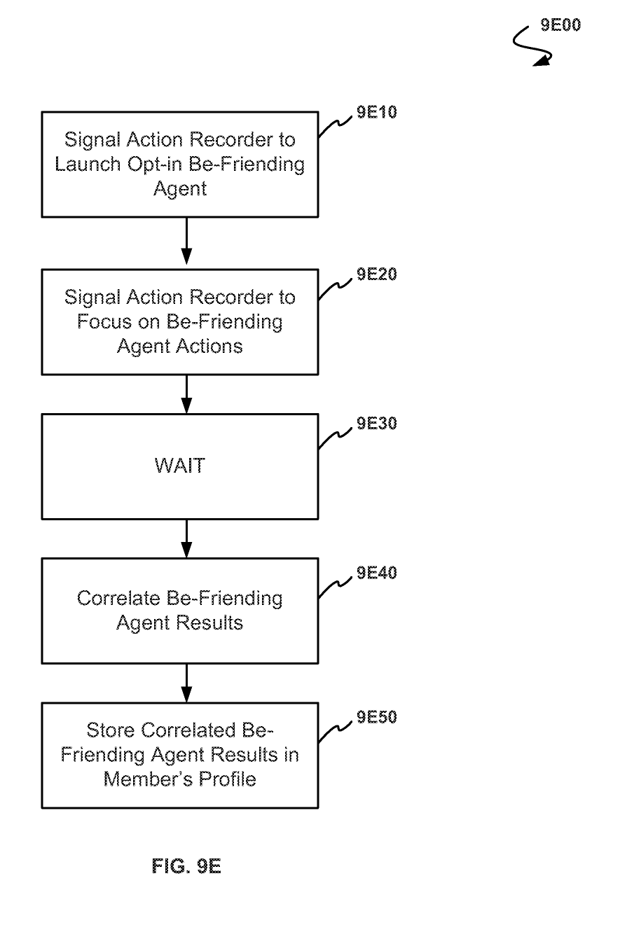

FIG. 9A shows a system for preparing a package for a presentation engine 9A00, in accordance with one embodiment. As an option, the present system 9A00 may be implemented in the context of the architecture and functionality of FIG. 1 through FIG. 8. Of course, however, the system 9A00 or any operation therein may be carried out in any desired environment.

In preferred embodiments, the system for preparing a package for a presentation engine 9A00 may look up the profile of the requesting provider and confirm that the provider has an election, and (optional) payment, and other account status needed for authorization and access to the marketing/mining program requested (operations 9A02, 9A04). Once the provider-requested program has been authorized, the specific database of matches is filtered (9A06) and packaged (9A08) for a presentation engine. This package is then used in the operation for invoking a presentation engine (9A10) to present program facets to a resource provider. Especially, though not exclusively in virtual worlds, a provider or advertiser might be presented with a dashboard to aid in the interpretation of data, and optionally to control program settings. For example, matches might have been matched and selected (see operation 9A06) according to some specific program (see operation 9A02) and such a program might include matching to various demographics. The definitions of demographics can be quite complex, so fairly sophisticated techniques for presentation are often appropriate. Accordingly a dashboard screen device might include two- or three-dimensional graphics, pull-downs for selection of canned graphs, and graphical navigation such as zoom, pan, rotate, etc. In addition to presentation of data, a dashboard might contain controls to dial-up or dial-down or otherwise modify any variables in the program.

FIG. 9B shows a system for preparing a package for a presentation engine 9B00, in accordance with one embodiment. As an option, the present system 9B00 may be implemented in the context of the architecture and functionality of FIG. 1 through FIG. 9A. Of course, however, the system 9B00 or any operation therein may be carried out in any desired environment.

In preferred embodiments, and using the terms “provider” and “advertiser” interchangeably in so far as referencing FIG. 9B, the system for preparing a package for a presentation engine 9B00 may look up the profile of the requesting provider and confirm that the provider has a marketing/mining program election, and has an account in good standing, and may confirm other account status needed for authorization and access to the particular marketing/mining program requested (see operations 9B02 and 9B04). Once the provider-requested program has been authorized, a best match advertisement is selected from a database corresponding to the provider's enabled advertising campaigns. The selected advertisement might then be customized in some facet corresponding to the available information in the member's profile (see operations 9B06 and 9B08). It should be noted that the member data accessible to a provider may be limited on the basis of the program or programs to which the provider has subscribed. Access to member profile data may be further limited by virtue of access limitations placed on the member profile data either explicitly by the member (e.g. opt-in, opt-out) or by default access limitations. The selected and optionally customized advertisement is then presented using a technique similar in function to the screen device 2G10, or alternatively by performing an operation to invoke a presentation engine (see operation 9B10).

Still discussing embodiments of operation 9B06 and 9B08, while the limitations are discussed in the paragraphs above, there are also extensions. Strictly as one example, while an advertisement might be selected solely on the basis of a single member's profile, an advertisement might be selected on the basis of that user's network of family and friends as may be indicated in the user's profile. In another embodiment, an advertisement might be in the form of a feed, or portion of a feed, such a feed having been set up by (or on behalf of) the user and linking to the user's friends and relatives. In this manner, if a user is inquiring about, for example tax preparers, the advertiser “H and R Brick” might feed comments made by the user's network of friends and family about “H and R Brick”. Of course a given feed might be filtered, even if relevant to the advertiser, depending on the nature of content in that feed.

Referring to the facility for a member to opt-in to one or more programs for presenting their dataset to marketers and other members, the member may be rewarded by a given opt-in selection. In particular, certain advertising campaigns may be extended to include widgets, screen devices, or use of other techniques to motivate a given member to opt-in to allowing release of particular data (see operation 9B06, 9B08, and 9B10). An advertiser might present a pop-up or banner question such as, “Are you one of the 15 members between the ages of 34 and 36 whom we will choose today for a free X? Opt-in for release of your age and find out”. Of course such a question is merely exemplary, and any device or question for motivating the member to opt-in might be constructed, possibly adapted to the already available member data, and presented to the member. Of course a presentation engine may have many embodiments in both the real world and in any virtual world. In virtual worlds, advertisements and or suggestions might be presented across time and space. That advertisement or suggestion might be presented to a member in many different venues, or even “along the way” between one venue and another. Of course not only advertisements, but also product placements are envisioned and reasonable.

It should be noted that the likelihood of a business transaction occurring increases as the target factor (i.e. extent of match or narrowness of match) increases. Similarly the likelihood of a business transaction occurring increases as the member takes more action (e.g. clicks through an advertisement) and/or takes on more commitment (i.e. watches a movie, agrees to take a survey, pays for a trial period, types in a promotion code, accepts a download, etc). This phenomenon is depicted in Table 4.

TABLE 4

Target Factor

| Commitment Level | Low/Medium | Medium/High |
|---|---|---|
| Higher | High | Very High |
| Lower | Low | Medium |

It is thus axiomatic that if a member's actions and commitments are recorded following the impression of an advertisement, the relationship between the impression and the action(s) or commitment(s) can be correlated (see operation 9B12). In some cases the correlation may be a weak correlation (e.g. the member responded to some facet of the advertisement). In other cases, the correlation may be a strong correlation (e.g. the member answered a survey mentioned in an advertisement), or even a direct correlation (e.g. the member completed the order form included in the advertisement and paid via credit card or electronic transfer).

In virtual worlds, all user human interface actions are recordable with known techniques, and any movement or visitation or purchase or chat or any other virtual world behavior might be recorded. Of course in a virtual world, and especially with use of positioners (e.g. mouse, 3-D mouse, gyro positioner, accelerometer, camera reference point, camera angle, etc.) infinitesimally small actions might be inconsequential (e.g. mousing in circles, aimlessly), or magnified (e.g. repeatedly, and without any user-intended reason, switching between one camera reference point and another), and thus the notion of focus might be implemented into a recording engine. In the case of such a recording engine, the operation 9B12 might send a signal to start recording with focus for some duration.

Actions taken (again movement or visitation, or purchase, or chat or any other virtual world behavior) might be recorded for subsequent correlation to other events (real or virtual). In some embodiments, a correlation may trigger a payment to the member in an amount calculated based on some fraction of the transaction amount in some currency. A transaction in this case may include the actual or prophetic transaction as directly correlated to the member's action, or it might be the actual or prophetic transaction involving the advertiser's payment for the advertising impression, or for the member's click-through action, and/or for any other action as may be recorded by the action recorder engine including the attendant variables implicit in dynamic identity template management discussed elsewhere within and agreed upon in the context of the business terms of the advertising campaign. For example, and especially in the context of a virtual world, actions may, and typically do include many verbs/actions/behaviors beyond clicks. In fact, virtual world actions or behaviors may be inferred. Such inferences can be calculated using heuristics. Moreover, especially in virtual worlds, correlation might span multiple visits or even the entire lifetime of the virtual profile. As can be seen, the operations for presenting advertisements (see operation 9B10) and the operations for capturing the member's actions (see operation 9B12) are intended to be correlated. More particularly, the presentation engine and the action recorder engine share data, at least including an identifier of any data presented by the presentation engine. Any ensuing member response, at least to the extent of recordable actions, can thus be correlated. Statistical responses as well as individual responses can be correlated and reported. In some cases such a correlation report might be generated and provided to an advertiser as an option, either as part of a marketing and sales program, or as a premium offering. In still other cases, aspects of a correlation report might be matched with an advertiser's cross promotion activities.

While recording, measuring and reporting correlations can be applied to the presentation of specific advertisement(s), so might recording, measuring and reporting correlations be applied to trends from within one or more populations. As is typical in large populations (whether in real or virtual worlds) there exists a huge amount of data to analyze. Accordingly techniques to analyze data and extract trends might be applied.

In particular, macro trends might not be relevant to any given user or advertiser. Strictly as an example, macro trends such as establishment of new industries and shifts from agrarian to industrial and then knowledge-based workers, while interesting to a sociologist, might not have relevance to a member, a provider, and/or an advertiser trying to extend the reach of, or more narrowly target, their impressions. However, identification of trends affecting family structure or living situations might be of interest to a member, a provider, and/or an advertiser. Even though the effect (i.e., changes in family structure) is a direct result of the cause (i.e. the shift from agrarian/industrial workers), it is the micro trend related to the effect that is of interest. Individual decisions and/or the outcomes of these individual decisions might be found from clusters, and might be identified as temporal micro-trends, and can thus result in a predictive capability. Of course an accurate predictive capability is generally valued by advertisers.

FIG. 9C is a depiction of a method for identifying trends from user behavior data, according to one embodiment. As an option, the present system 9C00 may be implemented in the context of the architecture and functionality of FIG. 1 through FIG. 9B. Of course, however, the system 9C00 or any operation therein may be carried out in any desired environment.

By way of background, and as earlier posited, in traditional marketplaces the commodity to be exchanged for valuable consideration most typically are arbitraged and traded on the basis of a well understood quantity of goods or services (e.g. a 1967 Mustang convertible, or 100 shares of GOOG). However, in the case of advertising and data mining, and more specifically, in the case of life stage decision support, the process and timing of selection of such a commodity is vexing. Strictly as examples and not to be limiting, aspects and components of the process and timing of selection of such commodities for sale/purchase might include the timing of the purchase of (for example) some advertising space on a particular property, or a data set including (for example) men aged 18-24 who have inquired about life insurance within the last 24 hours. Accordingly, techniques to dynamically extract cluster characteristics from a large data set and techniques to dynamically assign a value to such clusters are needed.

As earlier stated, FIG. 9C is a depiction of a method for identifying trends from user behavior data, according to one embodiment. The concept of a trend presented here includes (a) dynamically changing characteristic(s) of the makeup of a set of clusters (and any changing characteristics of one of more set members), and (b) dynamically changing value(s) of the aforementioned clusters or members of a cluster set. Presented just below is a method for dynamically identifying trends from user behavior data.

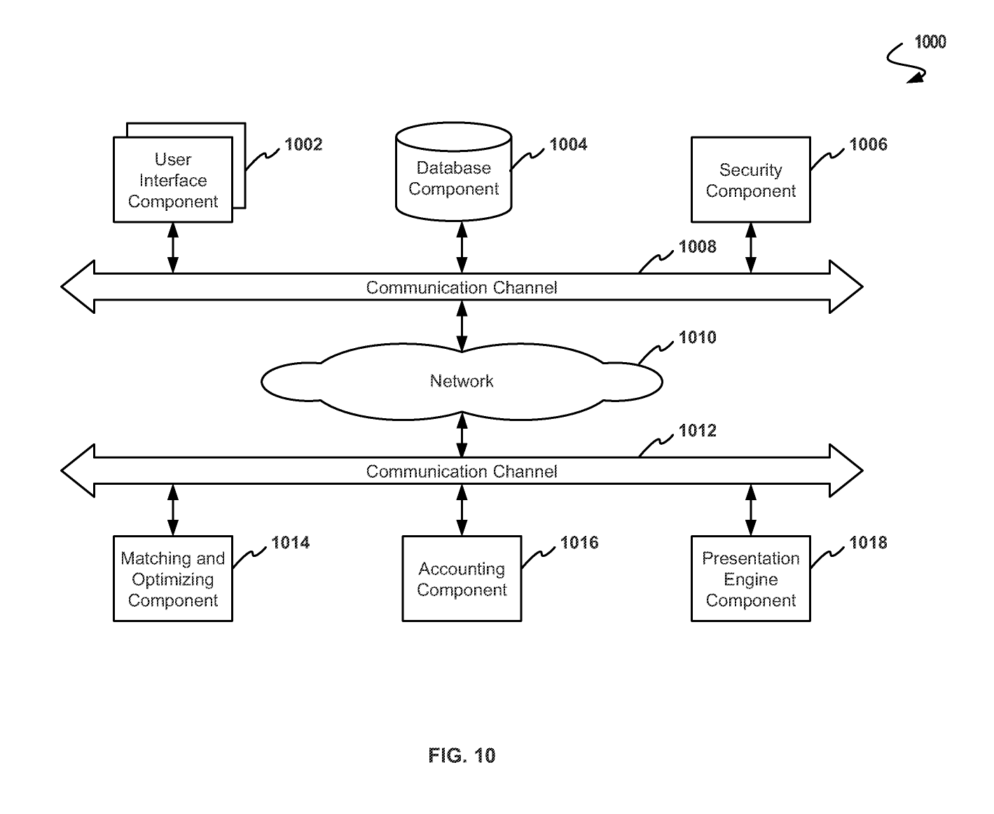

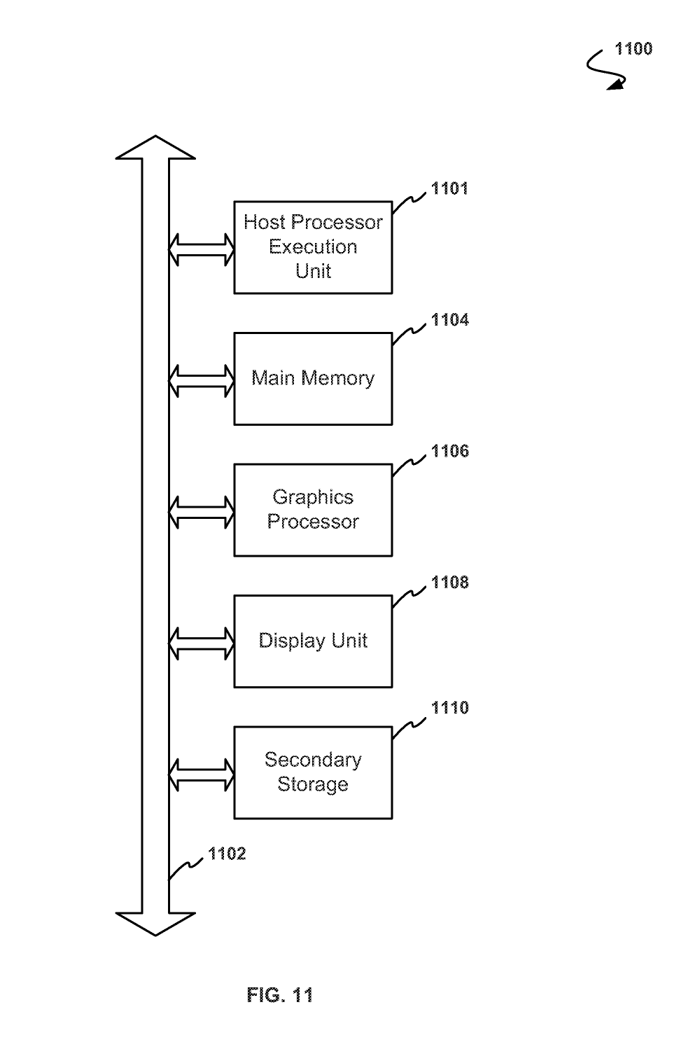

As shown, the method 9C00 includes an operation to capture data to be analyzed (operation 9C10). This data might be various representations of any or all data from a set of member profiles (real or virtual). Of course in many of the implementations contemplated and described in FIG. 10 and FIG. 11, there is included a database component 1004 and/or a secondary storage unit 1110. In such cases, operation 9C10 might merely entail the execution of a query. Continuing, the data captured in operation 1004 is clustered. Clustering techniques might rely solely on intrinsic activities, or in preferred embodiments, clustering techniques might include extrinsic techniques. In some cases, extrinsics might be defined by external sources including advertisers, service providers, or even from on-line markets that trade in extrinsics. That trade would work to establish a value, the degree of which may be market driven and expressed in any type of currency whether virtual- or real-world based. As is known in the related arts, clustering may include techniques to produce hierarchical clusters or partitions, and further might result in exclusive (disjointed) or non-exclusive (overlapping) cluster sets. In operation 9C20, certain clusters (and/or leafs) are excluded from the operation 9C40 to save the agglomeration. That is, as may happen with large data sets, some clusters formed (especially clusters formed using only intrinsics) may be deemed statistically insignificant and as such, those data are not necessarily useful in the valuing and trend analysis operations 9C50 and 9C60.

The operation 9C50 may be optionally applied to the agglomeration. That is (in a trivial example) the partition within the agglomeration of the data saved in 9C40 might include data (e.g. profiles) for married men aged 18-24, and the value of that data set might be established in a marketplace. A value might then be arbitraged for each member of a set of clusters. Continuing with this example, if some cluster (e.g. married men aged 18-24) is of interest to some prospective subscriber (e.g. advertiser, service provider, member), the subscriber might inquire as to the price of such a data set. The price can then be arbitraged through any exchange or market (e.g. “Right Media”, “Offerpal Media” “Iowa Electronic Markets”, “Hollywood Stock Exchange”, etc) that lists the cluster element of one or more of the cluster characteristics. Now will be appreciated that preferred embodiments of the current invention implement the use of clustering techniques including extrinsic techniques, where such extrinsics prescribe which characteristics (e.g., gender, age) are to be included as extrinsics in the clustering operations. Having one or more clusters based on extrinsics, and having an exchange or market, the cluster(s) can be valued and offered to the subscriber.

The aforementioned market valuation technique might be applied as discussed to a data set. It might also be applied to a specific advertising campaign or to a specific advertisement. In fact operation of various embodiments of the present invention may yield advertisers who wish to place advertisement(s) on any Internet properties associated with embodiments of the present invention. Those same advertisers might in turn wish to prosecute advertising campaigns or merely place ads on any of the affiliate Internet properties (e.g. affiliate social networks, affiliate virtual worlds, traditional Internet properties, or real-property advertising whether interactive or not in newspapers or on television, radio, billboards, etc.). Such syndication or cross-syndication is envisioned and possible within the context of the embodiments of the present invention. In fact syndication or cross-syndication including cross-licensing, cross-program remuneration, double-dip remuneration, virtual currency conversion, and other cross-program initiatives, including self-promotion of cross-program initiatives, are envisioned and possible within the context of the embodiments of the present invention.

Of course the method 9C00 includes identifying trends extracted from the characteristics of dynamically changing configurations of the set of clusters, and of identifying trends extracted from dynamically changing market value(s). To do so implies comparison of clusters or values over time, and applying statistics and mathematical techniques. Trend estimates give an indication of the underlying movement of a statistical series after irregular factors (e.g. the filtered items as in operation 9C30) have been discounted or removed.

In the method of 9C00 presented herein, both trends in the dynamic nature of clusters as well as trends in the valuation of those clusters can be estimated. Emphasis must be placed on the selection of a delay value used in 9C70. To further appreciate the concept of delay selection as in operation 9C70, consider a particular data cluster to be a perishable commodity, which would suggest using a short delay. As an example suggesting a long delay, some trend data can only be statistically accurate, and hence deemed to be of value, if captured and averaged over a long period of time. Moreover, especially in virtual worlds, correlation of data including for trend estimation might span multiple visits, or even over the entire lifetime of the virtual profile.

Further, on the topic of finding a value of a particular cluster or cluster set member 9C50, a specific embodiment of the method of 9C00 selects a single user's profile data capture 9C10 and that profile, in part or in its entirety, can then be valued on an exchange. Especially in virtual worlds, a valuation (through an exchange) of a user profile supports techniques for ranking and rating mentors. That is, if a member (for example) were to be ‘successful’ in their endeavors (especially related to life stage decisions), then he/she might feel qualified to provide mentoring to other members, and might possibly desire to be perceived as qualified to provide mentoring to other members. Similarly if a professional service provider were to be ‘successful’ in their delivery of services (especially related to providing professional service for life stage decisions), then they possibly might desire to be perceived or recognized as successful. In some embodiments, a user desiring to foster the perception of being successful might elect to issue virtual stock and list on an appropriate exchange. Once such shares have been issued and are at least initially valued on an exchange, the shares can be arbitraged, traded, and converted to/from any arbitrary currency. In further embodiments, one (or possibly more) exchanges might list the aforementioned currency and exchange rates into any other set of currencies, possibly including real currencies (e.g. USD, GBP, SFR, JPY) deposited with or traded through real or virtual means using real or virtual institutions.

Now, given the activities of listing a commodity exchangeable for a currency on an exchange, it is axiomatic that the exchange itself could represent an intersection between a member (or service provider or advertiser) and any other entity making a trade on the exchange. In some cases the entity making a trade on the exchange is a natural person acting as a natural person. In other cases the entity might be a virtual person acting as a proxy for a specific natural person. In still other cases, the entity might be a bot operating as an agent for a natural person, or the entity might be a bot operating as an agent for some organization (e.g. a company or another exchange).

Of course shares involved in trading might gain or lose value over time. It is envisioned and reasonable that natural persons behind any highly valued shares might wish to self-promote their personality or avatar. In some cases the exchange valuation may self-create notoriety, and such notoriety might be monetized by spinning off licenses to use or refer to the notorious or celebrated personality.

In some embodiments of a presentation engine and an action recording engine, one or more of the aforementioned screen devices may be used for presentation of marketing or advertising information 160 (e.g. an ad or an on-line survey) and for recording events 170 (e.g. click-through evidence of answering survey questions or completing a download). Of course any known methods for presenting information to a user and/or capturing user response via a computer display and human input devices may be used.

Such presentation of information followed by user action has important effects especially in the context of embodiments including dynamic identity template management. That is, since a presentation of a targeted message (e.g. of a marketing suggestion, or an invitation, or other customized message) to a user might cause the user to take action, it is reasonable and envisioned that the action recording engine 170 be adapted to record not only user actions, but also actions resulting from user actions that in turn result in further automated actions (e.g. a push of a subordinate template to a related subnet/site, or a pull of an updated copy of a profile from a related subnet/site). Operations suitable for automation of presentation of a targeted message and for automation of actions permitted by a user are presented herein, including in the discussions of FIG. 9D and FIG. 9E.

In still other embodiments, the correlation between the impression(s) and the action(s) or commitment(s) might be dynamic, and might be performed in real-time. In simpler cases the relationship between an impression and an action are more or less static; for example, the action of a user clicking on a link in an advertisement that in turn brings up a second advertisement. In more dynamic cases, and strictly as an option, the action of a user clicking on a link in an advertisement if that user had (for example) previously responded affirmatively to a specific question, and if that user's profile indicates that user is (for example) between the ages of 44 and 49, then (for example) that combination might bring up a second advertisement that is highly relevant to the user.

The foregoing examples are but illustrative examples, and in more general embodiments, any combinations of sequences of clicks considered together with any values or combination of values found in the user's profile or group of profiles (resulting from mining a member database containing multiple user's profiles) might produce highly specific and relevant impressions. Of course such a “state machine” might be defined in the context of operation 180 and, in fact, a state machine might be provided for any given advertiser, and still more specifically such a state machine might be provided for any advertiser's advertising or data mining campaign(s), including for selection of the next action in an advertising or data mining campaign. Of course such a state machine is merely an example of a model, and more sophisticated event-driven models might be defined. Thus, especially (but not only) in a virtual world, in a scenario with event models and behavioral models and some initial stimulus (e.g. a user clicks on some screen device, or a user enters a virtual location), an entire exchange of stimulus and response can be simulated to carry out the event-driven (and programmatic) behaviors of the model.

In some cases, the presentation may include multiple screens that can be navigated in similar fashion to navigation through Internet html pages, and may include hints and tips, help-text, pop-ups, helper avatars, and any other devices for navigation and/or for easing the absorption of complex data. Strictly as an option, such presentation and navigation aids may include access to acronym definitions and underlying credentialing requirements, and optionally an acronym dictionary.

Especially, though not exclusively in any virtual world embodiments of a presentation engine, various virtual world constructs might be used for presentation of marketing or advertising information or even infomercials, radio shows, podcasts or lectures. In fact a presentation engine in the context of a virtual world might support a lecture (hosted by a natural person lecturer, or by a recording), or a series of lectures (possibly with a viewable/printable syllabus), or a seminar or seminar series, or a conference, or a virtual radio program, or a decision circle, or any other forum where people can meet for communication, distance learning or exchange of ideas.

A possible and desired result of the one or more matches that may occur upon the aforementioned multi-axis match objects is a relationship to be established between a member and a provider. Such a relationship may progress in normal course and consummate in one or more successful transactions. Of course certain other relationships may not progress to the point of a desired action being taken, and/or any transaction may be regarded as less than successful. In either case, embodiments of the present invention permit and encourage feedback from members regarding service providers with whom they have had experiences. Accordingly various techniques including screen devices are provided to members for feedback. In any virtual world embodiments, nearly any object or location or avatar or entity or placement or advertisement can be rated by a user.

In some embodiments, questions, together with possible multi-valued answers (e.g. “yes, “no”) and/or ranked answers (e.g. “good”, “fair”, “poor”) and even numeric answers (e.g. “more than $100”), might be presented to the member for response. In preferred embodiments, the questions are defined and ratified by an oversight organization as may correspond to the type of goods or services provided. For example, the American Bar Association might ratify questions dealing with lawyers practicing elder law. Of course simple screen devices like tabular data with pull-down responses and/or radio buttons might be presented to a member. However any sort of input technique might be used. The member-supplied data is then mixed with other respondents, and statistical rankings of providers might be provided in member pages. Especially in virtual worlds, though not exclusively in virtual worlds, this moment in time is near optimal for collecting feedback about not only the recent experience, but also about contemplated changes. Multiple-choice questions or even subjective, open-ended questions (e.g. “How could we improve the experience?”) might be presented in an attempt to gather still more feedback from the respondent. In fact, if the respondent seems to be a willing or eager participant, the inquiry might be further extended to set up an impromptu focus group. Respondent's responses might be correlated with other respondents from the same target demographic or, especially in virtual worlds, an impromptu focus group might be set up in real-time in a specific virtual room where others might be present (in their virtual embodiment) for the same purpose.

FIG. 9D is a depiction of a method for adding extensible fields to a profile, according to one embodiment. As an option, the present system 9D00 may be implemented in the context of the architecture and functionality of FIG. 1 through FIG. 9C. In particular, system 9D00 might be included in embodiments of operation 9B06. Of course, however, the system 9D00 or any operation therein may be carried out in any desired environment.

As shown the system 9D00 begins by selecting identities from a user profile (see operation 9D10). The identities might be in the form of a profile or a subordinate profile, or any combination of field therein. Once one or more identities have been selected, they are scored for suitability for use in the generation and presentation of a message to the corresponding user. Of course it is possible that only zero or one identities exist, so in that case, the operation to score identities for suitability to a custom message 9D20 might be unnecessary. In the general case, however, scoring is accomplished using any and all information available to the operation. In some cases the aforementioned information might be sufficient to produce the desired customized message to the user; however in some cases, certain (needed or desired) information might not exist in the profile at that moment in time. Accordingly, in the case that certain (needed or desired) information might be retrieved or otherwise added to the profile, the operation 9D30 might suggest, request or facilitate the addition of an extensible field to the profile or identity.

Strictly as an example, if a physician (or agent) were soliciting to find and be-friend candidates for a drug trial, it might be useful to present to the subject user a message customized to that user's DNA information (e.g. candidates with the XYZ gene should report to Location A, those with the ABC gene should report to Location B). However, if the DNA information were not immediately available, or even if the profile or any attached identities do not contain DNA information or even an un-populated field for such DNA information, the physician or agent might extend the profile (through inclusion of an extensible field) to include the DNA field (see operation 9D30).

Of course, such a system 9D00, and in particular the operation 9D30 might operate in real-time while the user is viewing online. Accordingly, in some embodiments, the operation 9D30 is executed, but then continues without incurring a real-time delay for retrieval of the information that was the subject of the extension of the identity. One technique is to define an automated agent (bot) to retrieve information corresponding to the just-added extensible fields. As shown in operation 9D40, any number of agents can be defined and launched, and assuming the user has established appropriate permissions in the identity, the agent can retrieve the requested data.

FIG. 9E is a depiction of a method for launching an automated agent, according to one embodiment. As an option, the present system 9E00 may be implemented in the context of the architecture and functionality of FIG. 1 through FIG. 9D. In particular, system 9E00 might be included in embodiments of operation 9B12. Of course, however, the system 9E00 or any operation therein may be carried out in any desired environment.

As shown, the system 9E00 begins by signaling the action recorder to record not only user actions (e.g. mouse clicks) but also automated agent actions (see operations 9E10 and 9E20). Assuming the user has previously set permissions, or is affirmatively responsive to any be-friending automated agent (e.g. an opt-in query), then an action recorder might be able to monitor returns from such agents. Of course, there is often some user-response-time delay, and/or network delay, so implementations of system 9E00 might include some finite controlled delay time (see operation 9E30). After such an optional and controllable delay time, the system 9E00 might correlate any actions resulting from user actions and/or automated agent actions (operation 9E40) and optionally store any aspects of the correlation in the subject profile(s) or identities (see operation 9E50).

Returning to the example presented in the discussion of system 9D00, if the automated agent were in fact able to confirm or acquire user permissions to retrieve the user's DNA information, and was able in fact to retrieve such information, then such a fact might then be recorded in the user's profile, and used in any subsequent presentation to the user (e.g. “Congratulations—You are qualified as a candidate in the clinical drug trial. Please report to Location XYZ”). Of course the foregoing is but one example of a correlation. Many other and much more complex correlations are possible and envisioned, and are in fact supported by the disclosure herein, including the aforementioned disclosure of open-source platforms for developers.

Continuing with discussion of embodiments that might store any aspect of correlations in the subject profile, use of a state machine and/or event-driven simulation might be employed by an automated agent. Again using the example of a physician seeking candidates for a drug trial, information in addition to the aforementioned DNA information might be needed. However, requesting such information (e.g. a particular x-ray or MRI image) might itself require some information determined from the DNA information, and requesting such information might incur a charge. Thus it would be reasonable to defer requesting an x-ray or MRI until such time as the DNA information had been retrieved and analysed. This situation, and many like it, can be managed through the use of a state machine used in conjunction with the automated agent.

FIG. 10 depicts a possible mapping of a system for practicing the method for universal life stage decision support 100. As shown, a user interface component 1002, a database component 1004, and a security component 1006 are all in communication, one with another via a first communication channel 1008. Similarly, the matching and optimizing component 1014, accounting component 1016, and presentation engine component 1018 are in communication via a second communication channel 1012, as shown. In some embodiments, there may be optionally a network cloud 1010 for communication between the first communication channel 1008 and the second communication channel 1012, possibly through any number of subnetworks (which themselves may contain subnetworks) within the cloud. Also, in some embodiments, the first communication channel 1008 may be the same, or otherwise indistinguishable, from the second communication channel 1012. Within the flexibility of such possible mappings, one skilled in the art can readily see that the user interface component 1002 might be adapted to be operable on a laptop computer in communication with, for example, the transaction approval component, with such communication taking place over the network. In exemplary embodiments, there may be more than one instance of a user interface component 1002, and in some embodiments, one instance of a user interface component 1002 may share some or no similarities to a second or nth user interface component 1002.

FIG. 11 illustrates an exemplary system 1100 in which the architecture and/or functionality of the various previous embodiments may be implemented. As shown, a system 1100 is provided including at least one host processor 1101, which is connected to a communication bus 1102. The system 1100 also includes a main memory 1104. Control logic (software) and data are stored in the main memory 1104 which may take the form of random access memory (RAM).

The system 1100 also includes a graphics processor 1106 and a display 1108, i.e. a computer monitor.

In the present description, a single semiconductor platform may refer to a sole unitary semiconductor-based integrated circuit or chip. It should be noted that the term single semiconductor platform may also refer to multi-chip modules with increased connectivity and which simulate on-chip operation, and make substantial improvements over use of a conventional central processing unit (CPU) and bus implementation. Of course, the various modules may also be situated separately or in various combinations of semiconductor platforms.

The system 1100 may also include a secondary storage 1110. The secondary storage 1110 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1104 and/or the secondary storage 1110. Such computer programs, when executed, enable the system 1100 to perform various functions. Memory 1104, storage 1110, and/or any other storage are possible examples of computer-readable media.

In one embodiment, the architecture and/or functionality of the various previous figures may be implemented in the context of the host processor 1101, graphics processor 1106, an integrated circuit (not shown) that is capable of at least a portion of the capabilities of both the host processor 1101, and the graphics processor 1106.

Still yet, the architecture and/or functionality of the various previous figures may be implemented in the context of a general computer system, a circuit board system, a PDA, a game console system dedicated for entertainment purposes, an application-specific system, and/or any other desired system. For example, the system 1100 may take the form of a desktop computer, laptop computer, and/or any other type of logic. Still yet, the system 1100 may take the form of various other devices including, but not limited to, a personal digital assistant device, a mobile phone device, a television, etc.

Further, while not shown, the system 1100 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

We claim:

1. A method for template management as a part of a marketing and sales program for universal life stage decision support comprising:
collecting, at a host processor, user input to create provider profiles and member profiles;
creating, in a memory, multi-axis match objects from the provider profiles and member profiles, at least one of the member profiles comprising at least one masking property;
applying heuristics to create implied multi-axis match objects from the provider and member profiles;
filtering, scoring and selecting a selection set of matches from among a candidate set containing the multi-axis match objects and the implied multi-axis match objects;
defining at least one extensible profile field;
launching at least one automated agent corresponding to said at least one extensible field; and
recording reported action from said at least one automated agent.

2. The method of claim 1, wherein said collecting user input to create provider profiles and member profiles includes creating at least one user-defined identity .

3. The method of claim 2, wherein said user-defined identity includes at least one dynamically managed identity.

4. The method of claim 2, wherein collecting user input to create provider profiles and member profiles includes inheriting variables and variable values from a real world profile.

5. The method of claim 1, wherein collecting user input to create provider profiles and member profiles includes a screen area for presenting a control including at least one of, a content control, an operation control, a purpose control.

6. The method of claim 1, wherein said filtering, scoring and selecting includes filtering at least one virtual profile containing a plurality of dynamically managed identities.

7. The method of claim 6, wherein said scoring includes scoring using extensible fields.

8. The method of claim 6, wherein said scoring includes scoring using information from a user-authorized pull operation.

9. The method of claim 1, wherein launching at least one automated agent includes launching an automated agent for retrieving information for populating an extensible field.

10. The method of claim 1, wherein launching at least one automated agent includes a user opt-in confirmation.

11. The method of claim 1, wherein launching at least one automated agent correlates agent results.

12. The method of claim 1, wherein launching at least one automated agent includes confirming user permissions.

13. The method of claim 1, wherein launching at least one automated agent includes launching a plurality of automated agents.

14. The method of claim 1, wherein said recording reported action includes an event driven simulation.

15. The method of claim 1, wherein said recording reported action includes a state machine.

16. The method of claim 1, wherein said recording reported action includes a controlled delay.

17. The method of claim 1, wherein said recording reported action includes a correlation report.

18. The method of claim 1, wherein said recording reported action includes a correlation report match to a cross promotion.

19. An apparatus for template management as a part of a marketing and sales program for universal life stage decision support comprising:
a module for collecting user input to create provider profiles and member profiles;
a module for creating multi-axis match objects from the provider profiles and member profiles;
a module for applying heuristics to create implied multi-axis match objects from the provider and member profiles;
a module for filtering, scoring and selecting a selection set of matches from among a candidate set containing the multi-axis match objects and the implied multi-axis match objects;
a module for defining at least one extensible profile field;
a module for launching at least one automated agent corresponding to said at least one extensible field; and
a module for recording reported action from said at least one automated agent.

20. A computer program product embodied on a non-transitory computer readable medium, for template management as a part of a marketing and sales program for universal life stage decision support comprising:
computer code for collecting user input to create provider profiles and member profiles;
computer code for creating multi-axis match objects from the provider profiles and member profiles;
computer code for applying heuristics to create implied multi-axis match objects from the provider and member profiles;
computer code for filtering, scoring and selecting a selection set of matches from among a candidate set containing the multi-axis match objects and the implied multi-axis match objects;
computer code for defining at least one extensible profile field;
computer code for launching at least one automated agent corresponding to said at least one extensible field; and
computer code for recording reported action from said at least one automated agent.
